(19) United States
(12) Patent Application Publication
(10) Pub. No.: US 2026/0292244 A1
(43) Pub. Date: Sep. 24, 2026

(54) IMAGE DECODING DEVICE, IMAGE DECODING METHOD, AND PROGRAM

(71) Applicant: KDDI Corporation, Tokyo (JP)

(72) Inventors: Yoshitaka KIDANI, Saitama (JP); Haruhisa KATO, Saitama (JP); Kei KAWAMURA, Saitama (JP)

(73) Assignee: KDDI Corporation, Tokyo (JP)

(21) Appl. No.: 19/473,754

(22) PCT Filed: Mar. 5, 2024
(86) PCT No.: PCT/JP2024/008383

§ 371 Date: Oct. 8, 2025

(30) Foreign Application Priority Data
Apr. 13, 2023 (JP) 2023-065991

(51) Int. Cl. H04N 19/593; H04N 19/124; H04N 19/176

(52) U.S. Cl. CPC H04N 19/593; H04N 19/124; H04N 19/176

(57) ABSTRACT

An image decoding device includes a first intra-frame predicting part configured to generate first predicted pixels based on decoded pixels and control information, a second intra-frame predicting part configured to construct a BVP candidate list, derive one or more BVs for a block to be decoded from the BVD candidate list and generate second predicted pixels from the BVs, based on the decoded pixels and the control information, a storing part configured to store the decoded pixels, an inter-frame predicting part configured to generate third predicted pixels based on the stored decoded pixels and the control information and an adder configured to add the prediction residual and the first predicted pixels to the third predicted pixels to derive the decoded pixels.

### TECHNICAL FIELD

The present invention relates to an image decoding device, an image decoding method, and a program.

### BACKGROUND

NPLs 1 and 2 disclose intra block copy (IBC) and intra template matching prediction (Intra Template Matching Prediction (IntraTMP)).

In IBC and IntraTMP, a pixel is referred to from a decoded pixel region of a decoding-target frame to use this as a predicted pixel of a decoding target block.

A difference between IBC and IntraTMP is as follows. In IBC, a control signal for decoding a block vector representing coordinates to be referred to is explicitly transmitted by signaling. In contrast, in IntraTMP, a neighboring pixel is used as a template to search for a similar region instead of transmitting by signaling a control signal for decoding a block vector.

Although there is such a difference in signaling of a block vector, a pixel is copied from a reference block indicated by a block vector of a decoding target block to be used as a predicted pixel in both IBC and IntraTMP as illustrated in FIG. 2.

### CITATION LIST

### Non Patent Literature

[NPL 1] ITU-T H.266/VVC
[NPL 2] M. Coban et al., “Algorithm description of Enhanced Compression Model 7 (ECM 7)”, JVET-AB2025, 2022

### SUMMARY

### Technical Problem

However, in both of NPLs 1 and 2, a block vector is limited to one, which gives room for improvement to improve coding efficiency. In addition, in NPLs 1 and 2, a block is simply copied, which gives room for improvement to improve coding efficiency.

Hence, the present invention has been made in view of the above issues, and an object the present invention is to provide an image decoding device, an image decoding method, and a program with high coding efficiency.

### Solution to Problem

An image decoding device according to a first feature of the present invention includes a decoding part configured to decode control information and quantization values, a dequantizing part configured to dequantize the quantization values to derive transform coefficients, an inverse-transforming part configured to inverse-transform the transform coefficients to derive a prediction residual, a first intra-frame predicting part configured to generate first predicted pixels based on decoded pixels and the control information, a second intra-frame predicting part configured to construct a block vector candidate list, derive one or more block vectors for a block to be decoded from the block vector candidate list and generate second predicted pixels from the block vectors, based on the decoded pixels and the control information, the second intra-frame predicting part configured to generate, from two or more block vectors with integer pixel precision or fractional pixel precision for a block to be decoded, the second predicted pixels based on the decoded pixels and the control information, a storing part configured to store the decoded pixels, an inter-frame predicting part configured to generate third predicted pixels based on the stored decoded pixels and the control information, and an adder configured to add the prediction residual and the first predicted pixels to the third predicted pixels to derive the decoded pixels.

A decoding method according to the second feature of the present invention includes a step of decoding control information and quantization values, a step of dequantizing the quantization values to derive transform coefficients, a step of inverse-transforming the transform coefficients to derive a prediction residual, a step of generating first predicted pixels based on decoded pixels and the control information, a step of constructing a block vector candidate list, derive one or more block vectors for a block to be decoded from the block vector candidate list and generate second predicted pixels from the block vectors, based on the decoded pixels and the control information, a step of generating, from two or more block vectors with integer pixel precision or fractional pixel precision for a block to be decoded, the second predicted pixels based on the decoded pixels and the control information, a step of storing the decoded pixels, a step of generating third predicted pixels based on the stored decoded pixels and the control information, and a step of adding the prediction residual and the first predicted pixels to the third predicted pixels to derive the decoded pixels.

A program causing a computer to function as an image decoding device according to the third feature of the present invention, the image decoding device includes a decoding part configured to decode control information and quantization values, a dequantizing part configured to dequantize the quantization values to derive transform coefficients, an inverse-transforming part configured to inverse-transform the transform coefficients to derive a prediction residual, a first intra-frame predicting part configured to generate first predicted pixels based on decoded pixels and the control information, a second intra-frame predicting part configured to construct a block vector candidate list, derive one or more block vectors for a block to be decoded from the block vector candidate list and generate second predicted pixels from the block vectors, based on the decoded pixels and the control information, the second intra-frame predicting part configured to generate, from two or more block vectors with integer pixel precision or fractional pixel precision for a block to be decoded, the second predicted pixels based on the decoded pixels and the control information, a storing part configured to store the decoded pixels, an inter-frame predicting part configured to generate third predicted pixels based on the stored decoded pixels and the control information, and an adder configured to add the prediction residual and the first predicted pixels to the third predicted pixels to derive the decoded pixels.

According to the present invention, an image decoding device, an image decoding method, and a program with high coding efficiency can be provided.

### BRIEF DESCRIPTION OF THE DRAWINGS

FIG. 1 is a diagram illustrating an example of functional blocks of an image decoding device 200 according to one embodiment;

FIG. 2 is a diagram for illustrating IBC and IntraTMP;

FIG. 3 is a diagram illustrating an example of functional blocks of a second intra-frame predicting part 205 of the image decoding device 200 according to one embodiment;

FIG. 4 is a diagram for illustrating an example of a method of deriving a BV in a BV deriving part 205A of the second intra-frame predicting part 205 of the image decoding device 200 according to one embodiment;

FIG. 5 is a diagram for illustrating the example of the method of deriving a BV in the BV deriving part 205A of the second intra-frame predicting part 205 of the image decoding device 200 according to one embodiment;

FIG. 6 is a diagram for illustrating the example of the method of deriving a BV in the BV deriving part 205A of the second intra-frame predicting part 205 of the image decoding device 200 according to one embodiment;

FIG. 7 is a diagram for illustrating the example of the method of deriving a BV in the BV deriving part 205A of the second intra-frame predicting part 205 of the image decoding device 200 according to one embodiment;

FIG. 8 is a diagram for illustrating the example of the method of deriving a BV in the BV deriving part 205A of the second intra-frame predicting part 205 of the image decoding device 200 according to one embodiment;

FIG. 9 is a diagram for illustrating an example of a method of deriving a BV by IBC GPM in the BV deriving part 205A of the second intra-frame predicting part 205 of the image decoding device 200 according to one embodiment;

FIG. 10 is a diagram for illustrating an example of a method of blending a predicted pixel of a decoding target block in a second intra-frame predicted pixel generating part 205B of the second intra-frame predicting part 205 of the image decoding device 200 according to one embodiment;

FIG. 11 is a diagram for illustrating the example of the method of blending a predicted pixel of a decoding target block in the second intra-frame predicted pixel generating part 205B of the second intra-frame predicting part 205 of the image decoding device 200 according to one embodiment;

FIGS. 12A to 12C are each a diagram for illustrating the example of the method of blending a predicted pixel of a decoding target block in the second intra-frame predicted pixel generating part 205B of the second intra-frame predicting part 205 of the image decoding device 200 according to one embodiment;

FIG. 13 is a diagram for illustrating the example of the method of blending a predicted pixel of a decoding target block in the second intra-frame predicted pixel generating part 205B of the second intra-frame predicting part 205 of the image decoding device 200 according to one embodiment;

FIG. 14 is a diagram for illustrating the example of the method of blending a predicted pixel of a decoding target block in the second intra-frame predicted pixel generating part 205B of the second intra-frame predicting part 205 of the image decoding device 200 according to one embodiment;

FIG. 15 is a flowchart illustrating an example of a method of controlling decoding of a certain flag related to IBC in units of sequence;

FIG. 16 is a diagram illustrating an example of various flags related to IBC;

FIG. 17 is a flowchart illustrating an example of a method of decoding a flag for controlling whether or not bi-prediction IBC is applicable in a decoding part 201 of the image decoding device 200 according to one embodiment;

FIG. 18 is a flowchart illustrating the example of the method of decoding a flag for controlling whether or not bi-prediction IBC is applicable in the decoding part 201 of the image decoding device 200 according to one embodiment;

FIG. 19 is a flowchart illustrating an example of a method of decoding pred_mode_ibc_flag, which is a flag for controlling whether or not to apply IBC in units of decoding target block in the decoding part 201 of the image decoding device 200 according to one embodiment;

FIG. 20 is a flowchart illustrating an example of a method of selecting a mode of IBC in the decoding part 201 of the image decoding device 200 according to one embodiment;

FIG. 21 is a flowchart illustrating an example of a method of decoding a flag for controlling whether or not bi-prediction IBC merge is valid in units of decoding target block in the decoding part 201 of the image decoding device 200 according to one embodiment;

FIG. 22 is a flowchart illustrating an example of a method of decoding control information related to IBC merge in the decoding part 201 of the image decoding device 200 according to one embodiment;

FIG. 23 is a flowchart illustrating the example of the method of decoding control information related to IBC merge in the decoding part 201 of the image decoding device 200 according to one embodiment;

FIG. 24 is a flowchart illustrating an example of a method of decoding a flag for controlling whether or not IBC BVP/merge is valid in units of decoding target block in the decoding part 201 of the image decoding device 200 according to one embodiment;

FIG. 25 is a flowchart illustrating an example of a method of decoding control information related to IBC BVP/merge in the decoding part 201 of the image decoding device 200 according to one embodiment;

FIG. 26 is a flowchart illustrating an example of a method of decoding control information related to MBVD described above for refining a BV of IBC in the decoding part 201 of the image decoding device 200 according to one embodiment;

FIG. 27 is a flowchart illustrating an example of a method of applying second intra-frame prediction in units of block in the decoding part 201 of the image decoding device 200 according to one embodiment;

FIG. 28 is a flowchart of a case where a refinement BV is applied to a BV in the decoding part 201 of the image decoding device 200 according to one embodiment;

FIG. 29 is a flowchart illustrating an example of a method of decoding a flag for controlling whether or not bi-prediction IBC BVP is valid in units of decoding target block in the decoding part 201 of the image decoding device 200 according to one embodiment;

FIG. 30 is a flowchart illustrating an example of a method of decoding control information related to bi-prediction IBC BVP in the decoding part 201 of the image decoding device 200 according to one embodiment; and

FIG. 31 is a diagram illustrating an example of a method of binarization of an IBC merge index in the decoding part 201 of the image decoding device 200 according to one embodiment.

### DETAILED DESCRIPTION

Embodiments of the present invention will be described below with reference to drawings. Note that components in the following embodiments can be replaced with existing components and the like as appropriate, and various variations including a combination with another existing component are possible. Hence, the description of the following embodiments is not to limit the contents of the invention described in the scope of claims.

### First Embodiment

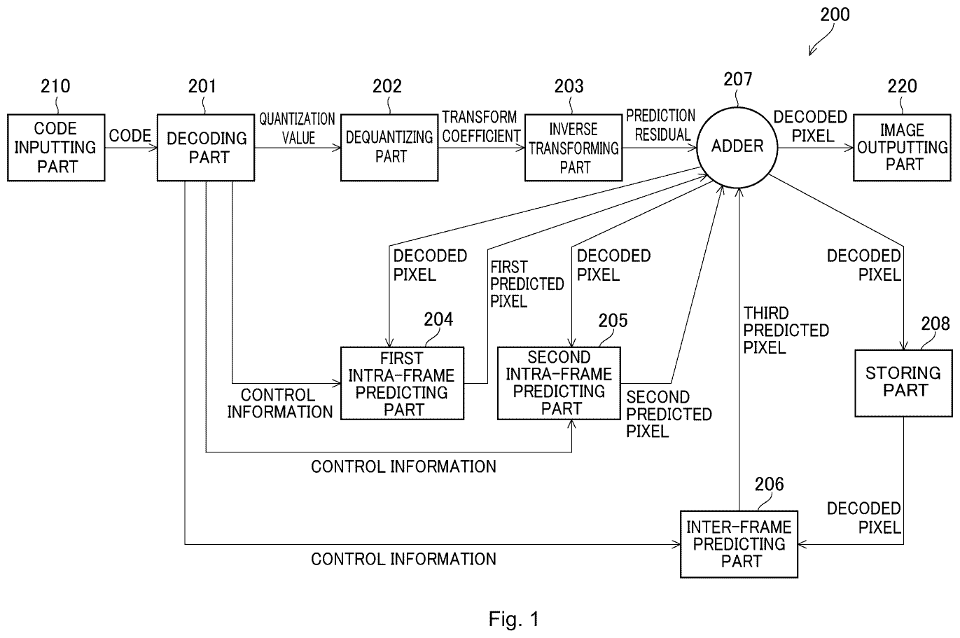

An image decoding device 200 according to the present embodiment will be described below with reference to FIG. 1 to FIG. 29. FIG. 1 is a diagram illustrating an example of functional blocks of the image decoding device 200 according to the present embodiment.

As illustrated in FIG. 1, the image decoding device 200 includes a code inputting part 210, a decoding part 201, a dequantizing part 202, an inverse transforming part 203, a first intra-frame predicting part 204, a second intra-frame predicting part 205, an inter-frame predicting part 206, an adder 207, a storing part 208, and an image outputting part 220.

The code inputting part 210 is configured to acquire code information coded by an image coding device.

The decoding part 201 is configured to decode control information and a quantization value from the code information input by the code inputting part 210. For example, the decoding part 201 is configured to perform variable-length decoding on the code information to thereby output control information and a quantization value.

Here, the quantization value is transmitted to the dequantizing part 202, and the control information is transmitted to the first intra-frame predicting part 204, the second intra-frame predicting part 205, and the inter-frame predicting part 206. Note that the control information includes information necessary for control of the first intra-frame predicting part 204, the second intra-frame predicting part 205, the inter-frame predicting part 206, and the like and may include header information such as a sequence parameter set, a picture parameter set, a picture header, and a slice header.

The dequantizing part 202 is configured to dequantize the quantization value transmitted from the decoding part 201 to derive transform coefficients. The transform coefficients are transmitted to the inverse transforming part 203.

The inverse transforming part 203 is configured to inverse-transform the transform coefficients transmitted from the dequantizing part 202 to derive a prediction residual. The prediction residual is transmitted to the adder 207.

The first intra-frame predicting part 204 is configured to generate a first predicted pixel to be added to the prediction residual by the adder 207, based on a decoded pixel derived via the adder 207 and the control information decoded by the decoding part 201. The first predicted pixel is transmitted to the adder 207.

The inter-frame predicting part 206 is configured to generate a third predicted pixel to be added to the prediction residual by the adder 207, based on a decoded pixel derived with reference to the storing part 208 and the control information decoded by the decoding part 201. The third predicted pixel is transmitted to the adder 207.

The storing part 208 is configured to accumulatively store decoded pixels transmitted from the adder 207. The decoded pixels are referred by the inter-frame predicting part 206 via the storing part 208.

The adder 207 is configured to add the prediction residual transmitted from the inverse transforming part 203 and any of the first to third predicted pixels transmitted from the first intra-frame predicting part 204, the second intra-frame predicting part 205, and the inter-frame predicting part 206, to derive a decoded pixel. The decoded pixel is transmitted to the image outputting part 220, the storing part 208, and the inter-frame predicting part 206.

### (Second Intra-Frame Predicting Part 205)

An example of a prediction method of the second intra-frame predicting part 205 will be described below.

### <Derivation of Block Vector>

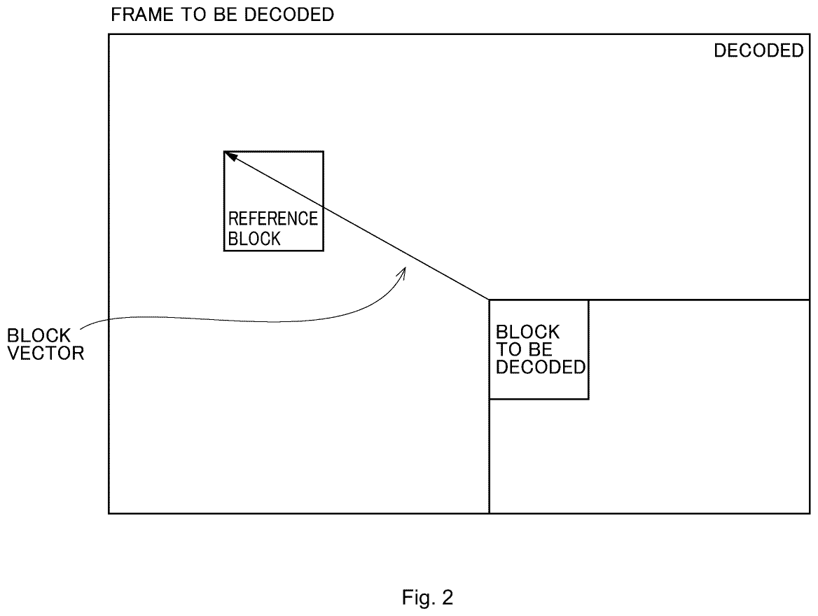

A role of the second intra-frame predicting part 205 is to derive one or more block vectors (BVs below) for a decoding target block as that illustrated in FIG. 2 and predict a pixel of a block referred for each BV (second intra-frame prediction), for highly precise prediction of a decoding target block in the adder 207 at a subsequent stage.

Examples of such second intra-frame prediction include intra block copy (IBC below) and intra template matching prediction (IntraTMP below) disclosed in NPLs 1 and 2.

The second intra-frame prediction can be applied when a decoding target block refers to another region by a BV, and IBC will be described below as an example of the second intra-frame prediction. Note that other examples include a mode of referring to a predicted pixel in a frame, such as IntraTMP.

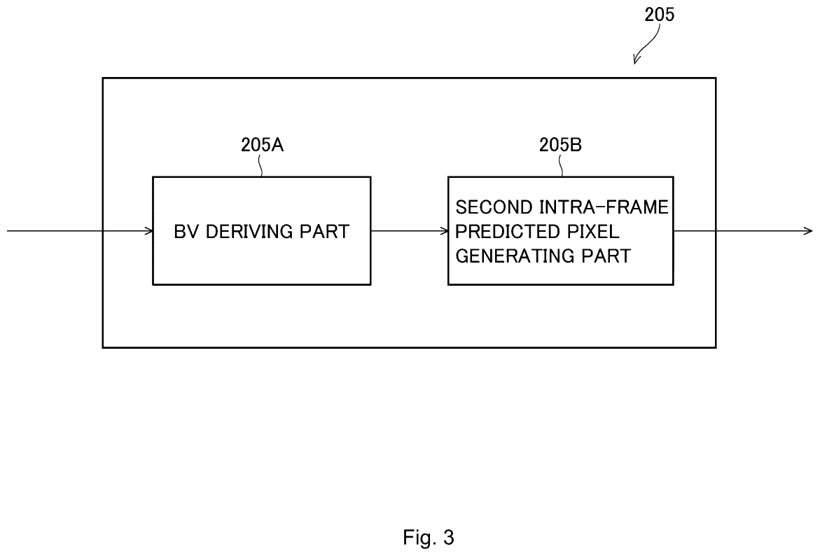

FIG. 3 illustrates an example of functional blocks of the second intra-frame predicting part 205. As illustrated in FIG. 3, the second intra-frame predicting part 205 includes a block vector deriving part (BV deriving part below) 205A and a second intra-frame predicted pixel generating part 205B.

The BV deriving part 205A is configured to derive one or more BVs for a decoding target block.

In the present embodiment, the BV deriving part 205A may derive one or more BVs by using at least one of the following four kinds of methods as methods of deriving an IBC BV(s). Note that a method to be used for deriving a BV(s) will be described in detail in the section for signaling (processing for decoding control information) of the decoding part 201 to be described below.
A. IBC block vector prediction (IBC BVP below)
B. IBC merge
C. IBC BVP/merge
D. IBC GPM

Here, both NPLs 1 and 2 disclose methods A and B of deriving a BV described above, but both of the derivation methods disclosed in NPLs 1 and 2 are methods assuming derivation of one BV.

An object (advantageous effects) of the present invention is to enable higher precision of second intra-frame prediction by derivation of two or more BVs, and eventually improvement of coding efficiency. Hence, in the following description related to methods A and B of deriving a BV(s), description will be given by focusing on differences of a case of deriving two or more BVs. Note that methods C and D of deriving BVs described above are new techniques assuming derivation of two or more BVs. IBC by derivation of two BVs (IBC based on bi-prediction or bi-prediction IBC) will be described below as an example of the second intra-frame prediction by derivation of two or more BVs (IBC based on multi-prediction or multi-prediction IBC).

### (A. IBC BVP)

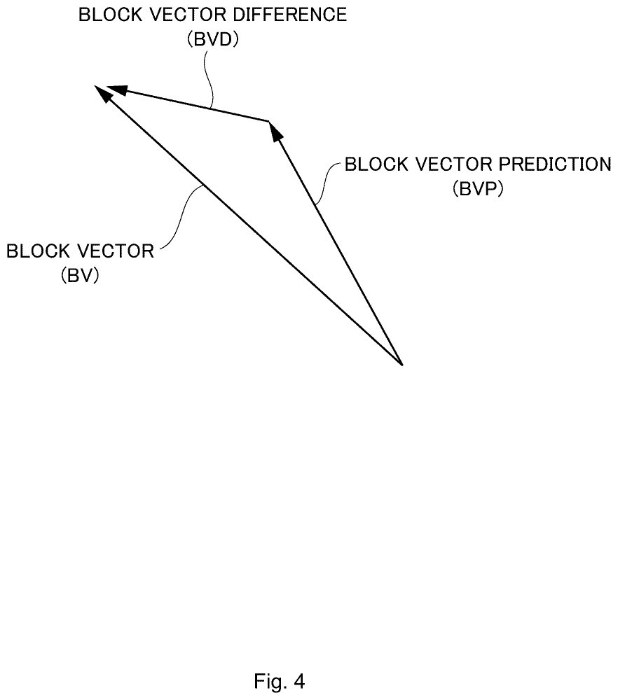

An example of a method of deriving a BV by IBC BVP in the BV deriving part 205A will be described below by using FIG. 4 to FIG. 6.

FIG. 4 illustrates an example that a BV is constituted of a block vector prediction (BVP) and a block vector difference (BVD).

In IBC BVP, the BV deriving part 205A derives a block vector prediction (BVP) and a block vector difference (BVD), based on values of pieces of control information related to a BVP and a BVD decoded by the decoding part 201, to derive a BV. Here, the control information related to a BVP and a BVD will be described in detail in the description of signaling in the decoding part 201.

An overview of the method of deriving a BVP in IBC BVP is as follows.

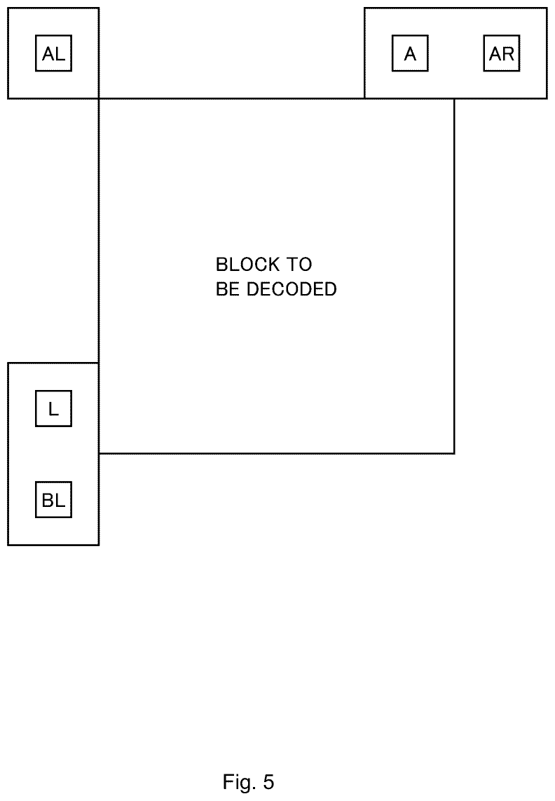

In step S1, the BV deriving part 205A checks whether or not an adjacent block of a decoding target block illustrated in FIG. 5 is decoded, and checks, if the adjacent block is decoded, whether or not the adjacent block has a BV (whether or not a BV is usable).

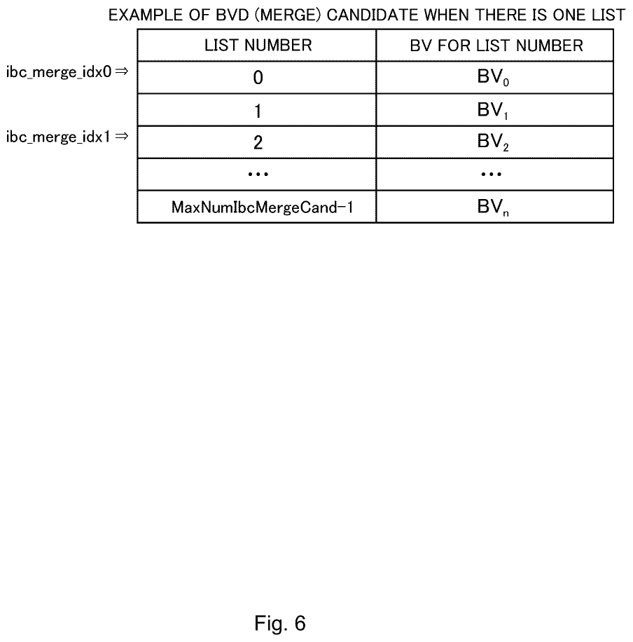

In step S2, the BV deriving part 205A registers the BV of the adjacent block having the BV, to a list as a BVP candidate (BVP candidate list below) illustrated in FIG. 6.

In step S3, the BV deriving part 205A selects a BVP from the BVP candidate list, based on the value of control information (IBC BVP flag or IBC BVP index) related to the BVP decoded in the decoding part 201.

Here, the number (locations) of adjacent blocks for each of which whether or not the block is decoded and whether or not the block has a BV are checked in step S1 may be two types (“A” and “L” in FIG. 5) as in NPL 1 or may be five types (“A”, “L”, “AR”, “LB”, and “AL” in FIG. 5) as in NPL 2.

The order of the adjacent blocks for checking above may be the same as a corresponding one of NPLs 1 and 2. Here, “A”, “L”, “AR”, “LB”, and “AL” respectively denote “Above”, “Left”, “Above Right”, “Left Bottom”, And “Above Left” in NPLs 1 and 2.

Here, the BV deriving part 205A can use a BV of a neighboring block (referred to as a spatial BVP in NPL 2), a BV used in the past (referred to as a history BVP in NPL 2), and the like, as BVP candidates.

In step S1, when a BV for which whether or not to be usable is newly checked is the same as a BV already checked to be usable, the BV for which whether or not to be usable is newly checked may be determined not to be usable.

Further, the order of registering BVs (BVP candidates) determined to be usable in step S1 to the BVP candidate list may be reordered in a certain reordering method. This reordering method will be described below in detail.

An overview of the method of deriving a BVD in IBC BVP is as follows.

In step S1, the BV deriving part 205A derives a BVD, based on control information related to a BVD.

In step S2, the BV deriving part 205A rounds the BVD derived in step S1, based on control information related to the pixel precision of the BVD.

Here, the method of deriving a BVD, based on control information related to a BVD can be configured by a method similar to that of NPL 1. Specifically, the decoding part 201 decodes (or infers) the size (absolute value) of the BVD and the value of control information related to code of the BVD, and the BV deriving part 205A derives a BVD from these values.

Lastly, the BV deriving part 205A adds the derived BVP and BVD to derive a BV.

The above is an overview of the method of deriving a BV in IBC BVP.

As another example, in IBC BVP, in a case of deriving two or more BVs, the BV deriving part 205A may derive a BVP and a BVD necessary for deriving each BV, in the following method.

In step S1, the BV deriving part 205A checks whether or not an adjacent block of a decoding target block illustrated in FIG. 5 is decoded, and checks, if the adjacent block is decoded, whether or not the adjacent block has a BV (whether or not a BV is usable).

In step S2, the BV deriving part 205A registers the BV of the adjacent block having the BV, to a list as a BVP candidate (BVP candidate list below) illustrated in FIG. 6.

In step S3, the BV deriving part 205A selects two or more different BVPs from the BVP candidate list, based on the values of pieces of control information (IBC BVP flag or IBC BVP index) related to the two or more different BVPs decoded in the decoding part 201.

Note that, when the BV deriving part 205A derives a BV(s) corresponding to one or more indices in the BVP candidate list, each of the second and subsequent indices is desirably a relative index based on the immediately previous index. Details will be described below. Here, the number (locations) of adjacent blocks for each of which whether or not the block is decoded and whether or not the block has a BV are checked in step S1 may be two types (“A” and “L” in FIG. 5) as in NPL 1 or may be five types (“A”, “L”, “AR”, “LB”, and “AL” in FIG. 5) as in NPL 2.

The order of the adjacent blocks for checking above may be the same as a corresponding one of NPLs 1 and 2. Here, “A”, “L”, “AR”, “LB”, and “AL” respectively denote “Above”, “Left”, “Above Right”, “Left Bottom”, And “Above Left” in NPLs 1 and 2.

Here, the BV deriving part 205A can use a BV of a neighboring block (referred to as a spatial BVP in NPL 2), a BV used in the past (referred to as a history BVP in NPL 2), and the like, as BVP candidates.

In step S1, when a BV for which whether or not to be usable is newly checked is the same as a BV already checked to be usable, the BV deriving part 205A may determine the BV for which whether or not to be usable is newly checked, not to be usable.

Further, the BV deriving part 205A may reorder the registration of BVs (BVP candidates) determined to be usable in step S1 to the BVP candidate list, in a certain reordering method. This reordering method will be described below in detail.

An overview of the method of deriving a BVD in IBC BVP is as follows.

In step S1, the BV deriving part 205A derives a BVD, based on pieces of control information related to two or more different BVDs.

In step S2, the BV deriving part 205A rounds each of the two or more different BVDs derived in step S1, based on control information related to the pixel precision of the BVD.

Here, the method of deriving a BVD, based on control information related to a BVD can be configured by a method similar to that of NPL 1. Specifically, the decoding part 201 decodes or infers the size (absolute value) of the BVD and the value of control information related to code of the BVD, and the BV deriving part 205A derives a BVD from these values.

Lastly, the BV deriving part 205A adds the derived two or more different BVPs and two or more respective different BVDs to derive two or more different BVs.

The above is an overview of the method of deriving BVs in bi-prediction (or multi-prediction) IBC BVP for deriving two or more BVs.

### (B. IBC Merge)

An example of a method of deriving a BV by IBC merge in the BV deriving part 205A will be described below by using FIG. 4 to FIG. 7.

In IBC merge, different from IBC BVP, the BV deriving part 205A derives only a BVP to directly derive the BVP as a BV, without deriving a BVD.

An overview of the method of deriving a BV in IBC merge is as follows.

In step S1, the BV deriving part 205A checks whether or not an adjacent block of a decoding target block illustrated in FIG. 5 is decoded, and checks, if the adjacent block is decoded, whether or not the adjacent block has a BV (whether or not a BV is usable).

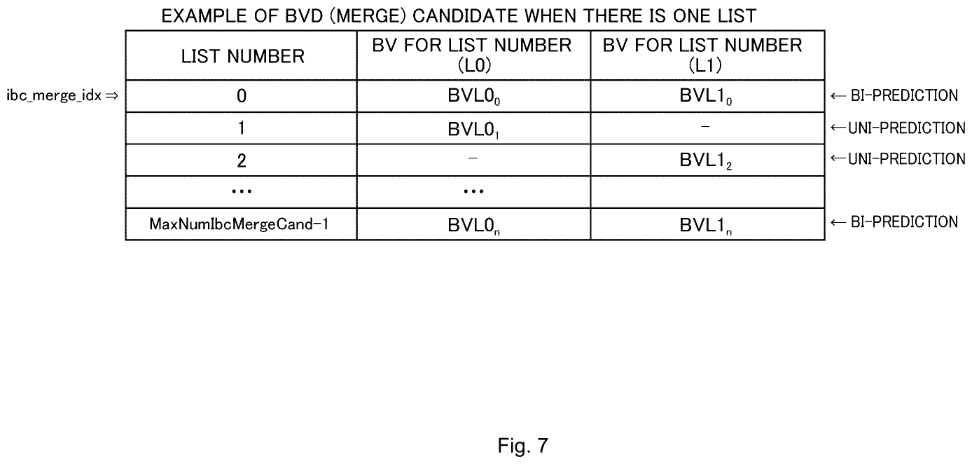

In step S2, the BV deriving part 205A registers the BV of the adjacent block having the BV, to a list (referred to as a BVP candidate list or a merge candidate list below) as a BVP candidate (or referred to as a merge candidate) illustrated in FIG. 6 or FIG. 7.

In step S3, the BV deriving part 205A selects a BVP from the BVP candidate list, based on the value of control information (IBC merge index) related to the BVP decoded in the decoding part 201, to derive the BVP as a BV.

Here, the number (locations) of adjacent blocks for each of which whether or not the block is decoded and whether or not the block has a BV are checked in step S1 may be two types (“A” and “L” in FIG. 5) as in NPL 1 or may be five types (“A”, “L”, “AR”, “LB”, and “AL” in FIG. 5) as in NPL 2.

The order of the adjacent blocks for checking above may be the same as a corresponding one of NPLs 1 and 2. Here, “A”, “L”, “AR”, “LB”, and “AL” respectively denote “Above”, “Left”, “Above Right”, “Left Bottom”, And “Above Left” in NPLs 1 and 2.

Here, a BVP candidate can use a BV of a neighboring block (referred to as a spatial merge in NPL 2), a BV used in the past (referred to as a history merge in NPL 2), the average of BVs (referred to as a pairwise average merge in NPL 2), and the like.

In step S1, when a BV for which whether or not to be usable is newly checked is the same as a BV already checked to be usable, the BV deriving part 205A may determine the BV for which whether or not to be usable is newly checked, not to be usable.

Further, the BV deriving part 205A may reorder the registration of BVs (BVP candidates) determined to be usable in step S1 to the BVP candidate list, in a certain reordering method. This reordering method will be described below in detail.

The above is an overview of the method of deriving a BV in IBC merge.

Here, in a case of deriving two or more BVs in IBC merge, the BV deriving part 205A may derive two or more BVs in a method as those below.

As an example, the BV deriving part 205A may create one BVP candidate list (or merge candidate list) as illustrated in FIG. 6 and thereafter select two or more BVP candidates in the BVP candidate list according to the values of two or more pieces of control information (IBC merge indices) indicating BVP candidates (or merge candidates) in a BVP candidate list decoded by the decoding part 201, to derive the BVP candidates as respective BVs.

Note that, when the BV deriving part 205A derives a BV(s) corresponding to one or more indices in the BVP candidate list, each of the second and subsequent indices is desirably a relative index based on the immediately previous index. Details will be described below.

Alternatively, the BV deriving part 205A may fixedly select one or more highest-ranked ones in the BVP candidate list to derive a BV(s). In this case, the BV deriving part 205A preferably performs reordering of the BVP candidates in a BVP candidate list to be described below. In this configuration, by fixedly selecting part of two or more BVs, an amount of coding indices for deriving derive the two or more BVs is not required, which can improve coding efficiency.

As another example, the BV deriving part 205A may individually configure BVP candidate lists for the number of BVs held by a decoding target block as illustrated in FIG. 7 and thereafter derive two or more BVs from one index.

For example, when a neighboring block holds a plurality of BVs as BVP candidates, the BV deriving part 205A registers each of the BVs to a corresponding BVP candidate list. By constructing a plurality of BVP candidate lists and configuring indices in common as described above, one or more BVs can be derived from one index. For example, when a decoding target block holds up to two BVs, the BV deriving part 205A may construct two lists (for example, L0 list and L1 list similar to those of normal intra-frame prediction) and derive one BV corresponding to an index from L0 list while deriving one BV corresponding to the index from L1 list. If a BV corresponding to the index is present only in one of L0 list and L1 list, the BV deriving part 205A may use the one.

### (C. IBC BVP/Merge)

An example of a method of deriving a BV by IBC BVP/merge in the BV deriving part 205A will be described below by using FIG. 4 to FIG. 6 and FIG. 8.

IBC BVP/merge is a method of deriving, in order to derive two (or two or more) BVs, the first BV, based on the method of deriving a BV in IBC BVP described above, and deriving the other BV (or the two or more remaining BVs), based on the method of deriving a BV in IBC merge described above. A concrete derivation method is as follows.

First, in IBC BVP/merge, in the same derivation method as that for IBC BVP, the BV deriving part 205A derives a BVP and a BVD, based on the values of pieces of control information related to the BVP and the BVD decoded by the decoding part 201 and adds the derived BVP and BVD to derive the first BV.

Second, in IBC BVP/merge, in the same derivation method as that for IBC BVP, the BV deriving part 205A selects a BVP from a BVP candidate list, based on the value of the control information (IBC merge index) related to the BVP decoded by the decoding part 201, to derive the BVP as the second BV.

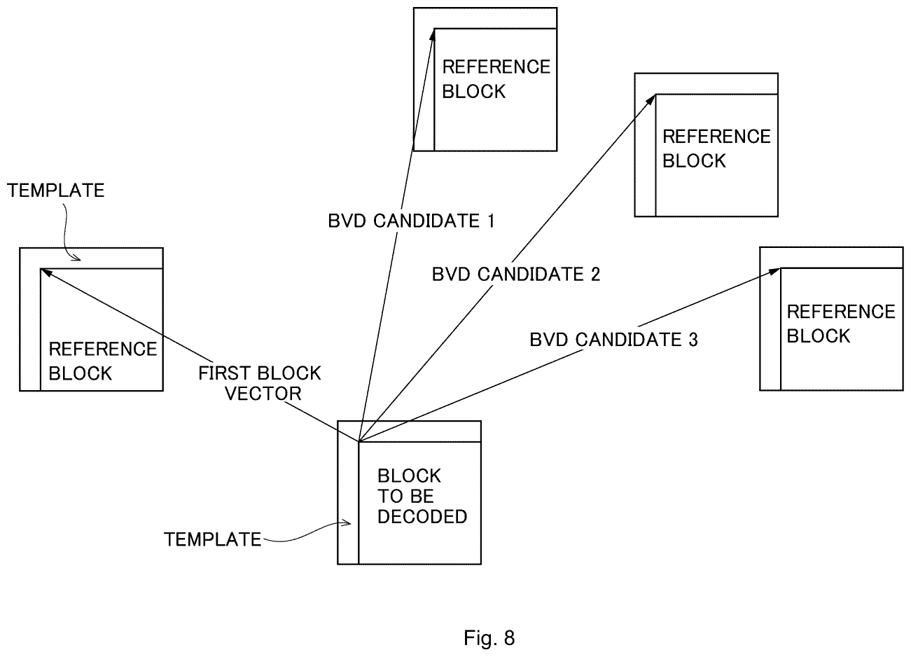

As another example, as illustrated in FIG. 8, the BV deriving part 205A may create a template (i.e., a certain neighboring pixel of a reference block being a BV reference destination), based on the first BV thus derived and evaluate the similarity between the template and a template (certain neighboring pixel of the reference block being the reference destination) of each BVP candidate (each IBC merge candidate) in the BVP candidate list of IBC merge (compare template costs), to derive the BVP candidate (IBC merge candidate) having the highest similarity (corresponding to the lowest template cost) as the second BV of IBC BVP/merge.

Alternatively, as another example, the BV deriving part 205A may select a BVP from the BVP candidate list in IBC merge, based on the value of the control information (IBC merge index) related to the BVP decoded in the decoding part 201, to derive the BVP as the second BV.

Here, the BV deriving part 205A may use the template of a decoding target block instead of a template based on a BV derived in IBC BVP, as a target of evaluation of similarity with the template of each IBC merge candidate.

Note that the BV deriving part 205A can use the sum of squared error (SSE), the sum of absolute difference (SAD), or the like for the template similarity evaluation (template cost comparison).

A certain pixel of a template created in the template similarity evaluation may be a decoded pixel of one pixel line adjacent to the left portion or an upper portion of each block.

When no decoded pixel adjacent to the left portion or the upper portion is present at a picture boundary or a slice boundary, the BV deriving part 205A may perform template similarity evaluation by using a decoded pixel at a usable location.

When two or more derivation target BVs are present, the BV deriving part 205A may derive BVP candidates in the descending order of template similarity (ascending order of template cost).

A detailed procedure of the method of deriving a BV in IBC BVP/merge is as follows.

An overview of the method of deriving a BVP based on the method of deriving a BV by IBC BVP in IBC BVP/merge is as follows.

In step S1, the BV deriving part 205A checks whether or not an adjacent block of a decoding target block illustrated in FIG. 5 is decoded, and checks, if the adjacent block is decoded, whether or not the adjacent block has a BV (whether or not a BV is usable).

In step S2, the BV deriving part 205A registers the BV of the adjacent block having the BV, to a list as a BVP candidate (BVP candidate list below) illustrated in FIG. 6.

In step S3, the BV deriving part 205A selects a BVP from the BVP candidate list, based on the value of control information (IBC BVP flag or IBC BVP index) related to the BVP decoded in the decoding part 201.

Here, the number (locations) of adjacent blocks for each of which whether or not the block is decoded and whether or not the block has a BV are checked in step S1 may be two types (“A” and “L” in FIG. 5) as in NPL 1 or may be five types (“A”, “L”, “AR”, “LB”, and “AL” in FIG. 5) as in NPL 2.

The order of the adjacent blocks for checking above may be the same as a corresponding one of NPLs 1 and 2. Here, “A”, “L”, “AR”, “LB”, and “AL” respectively denote “Above”, “Left”, “Above Right”, “Left Bottom”, And “Above Left” in NPLs 1 and 2. Here, the BV deriving part 205A can use a BV of a neighboring block (referred to as a spatial BVP in NPL 2), a BV used in the past (referred to as a history BVP in NPL 2), and the like, as BVP candidates.

In step S1, when a BV for which whether or not to be usable is newly checked is the same as a BV already checked to be usable, the BV deriving part 205A may determine the BV for which whether or not to be usable is newly checked, not to be usable.

Further, the BV deriving part 205A may reorder the registration of BVs (BVP candidates) determined to be usable in step S1 to the BVP candidate list, in a certain reordering method. This reordering method will be described below in detail.

An overview of the method of deriving a BVD based on the method of deriving a BV by IBC BVP in IBC BVP/merge is as follows.

In step S1, the BV deriving part 205A derives a BVD, based on control information related to a BVD.

In step S2, the BV deriving part 205A rounds the BVD derived in step S1, based on control information related to the pixel precision of the BVD.

Here, the method of deriving a BVD, based on control information related to a BVD can be configured by a method similar to that of NPL 1. Specifically, the decoding part 201 decodes or infers the size (absolute value) of the BVD and the value of control information related to code of the BVD, and the BV deriving part 205A derives a BVD from these values.

The BV deriving part 205A adds the derived BVP and BVD to derive the first BV.

An overview of the method of deriving the second BV based on the method of deriving a BV by IBC merge in IBC BVP in IBC merge is as follows.

Note that, in IBC BVP/merge, the BV deriving part 205A may construct two different BV candidate lists (i.e., one is a BVP candidate list for IBC BVP, and the other is a merge candidate list for IBC BVP/merge) in BV derivation of IBC BVP and BV derivation of IBC merge.

As another example, the BV deriving part 205A may derive the second BV by template similarity evaluation based on the first BV described above to derive the second BV, as follows.

In step S1, the BV deriving part 205A uses, as a template, a neighboring pixel of a block referred for the first BV or a decoding target block.

In step S2, the BV deriving part 205A evaluates similarity between the template derived in step S1 and a corresponding pixel of a block referred for each BVP candidate of the BVP candidate list.

In step S3, the BV deriving part 205A selects the BVP having the highest similarity, to derive the BVP as the second BV.

Here, the BV deriving part 205A does not include, as the target of the similarity evaluation, a BVP candidate identical to the first BV among the BVP candidates in the BVP candidate list in step S2.

Alternatively, the BV deriving part 205A does not register the BVP candidate identical to the first BV in the BVP candidate list in step S2, to the BVP candidate list at the stage of constructing the list.

Alternatively, in step S3, the BV deriving part 205A may reorder the registration of the BVP candidates in the BVP candidate list in the descending order of similarity, and select a BVP, based on the value of control information (IBC merge index) related to the BVP decoded in the decoding part 201, to derive the BVP as a BV.

The above is an overview of the method of deriving a BV in IBC BVP/merge.

### (D. IBC GPM)

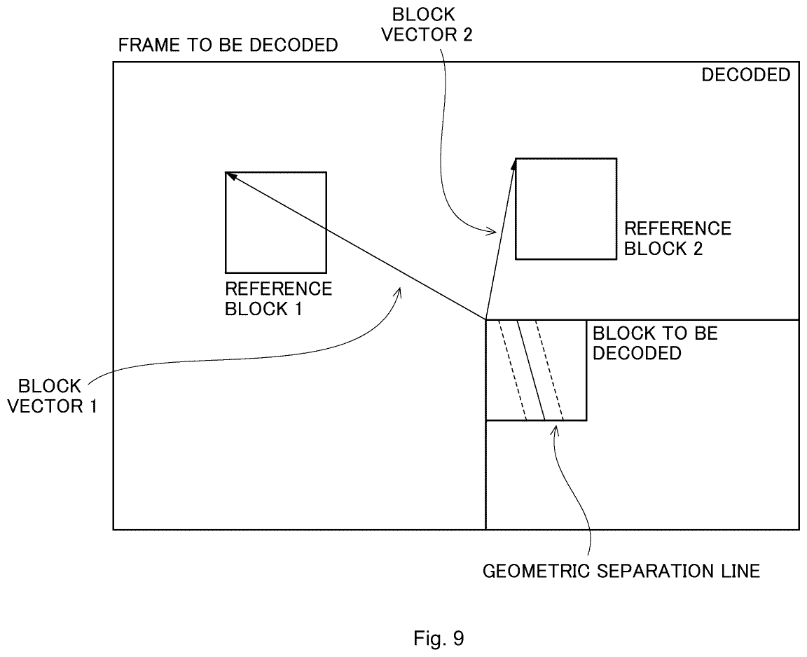

An example of a method of deriving a BV by IBC GPM in the BV deriving part 205A will be described below by using FIG. 9.

In IBC GPM, as illustrated in FIG. 9, in a state where a decoding target block is divided into two by any straight line (solid line in FIG. 9) selected from straight-line (geometric partitioning line) candidates of a plurality of different patterns, similarly to the geometric block partitioning mode (GPM, Geometric Partitioning Mode) disclosed in NPL 1, the BV deriving part 205A derives one or more different BVs for each partitioned region and weighted-averages the reference destinations (pixels of reference blocks) of BVs according to the respective distances from the partitioning line.

Here, the BV deriving part 205A may derive a BV necessary for the IBC GPM similarly to the IBC merge described above.

The BV deriving part 205A may identify a candidate for a partitioning line in IBC GPM, based on control information specifying the candidate for the partitioning line in GPM disclosed in NPL 1 or 2.

### <Pixel Precision>

Note that the BV deriving part 205A can configure the pixel precision of a BV to derive, at an integer pixel precision or can configure the pixel precision at a decimal pixel precision.

IBC is considered as a coding technique for a screen image. However, in a case of applying IBC to a natural image captured by a camera, by configuring the pixel precision of a BV at a decimal pixel precision (specifically, generating a predicted pixel by using an interpolation filter similarly to normal inter-frame prediction), the prediction precision can be increased.

The BV deriving part 205A can adoptively select a plurality of different pixel precisions.

Specifically, the BV deriving part 205A may configure the pixel precision of a BV at a plurality of different integer pixel precisions or may configure the pixel precision at a plurality of different decimal pixel precisions.

For example, the BV deriving part 205A can also change the pixel precision of a BV in units of sequence and/or units of picture and/or units of slice and/or units of block.

In other words, the BV deriving part 205A may change the pixel precision of a BV for each combination of any ones of units of sequence, units of picture, units of slice, and units of block.

For selection of a pixel precision of a BV in units of block, NPL 1 discloses a technique for applying adaptive motion vector resolution (AMVR) to IBC.

Concretely, the technique is for, in derivation of a BV in IBC, selecting pixel precision of a BVD from 1-pixel precision and 4-pixel precision and eventually rounding the BV according to the selected pixel precision of the BVD.

As an option of this AMVR, the BV deriving part 205A may add the above-described decimal pixel precision (for example, ¼-pixel precision and/or ½-pixel precision).

As another example, the BV deriving part 205A can also change the pixel precision of a BV according to the number of BVs of a decoding target block.

For example, the BV deriving part 205A can use decimal pixel precision for the pixel precision of a BV when the number of BVs is one, and can use integer pixel precision for the pixel precision for BVs when the number of BVs is two or more.

With an increase in the number of BVs, second intra-frame prediction generally becomes more precise, while processing load required for BV derivation increases. Hence, with an increase in the number of BVs, the pixel precision of BVs is made coarser, to maintain the prediction precision of second intra-frame prediction while obtaining effects of suppressing decoding processing load.

For example, the BV deriving part 205A may configure the pixel precision of a BV at integer precision when the number of BVs is two or two or more (selectable pixel precisions may be limited only to integer precisions).

On the other hand, the BV deriving part 205A may configure the pixel precision of a BV at integer pixel precision or decimal pixel precision (need not limit a selectable pixel precision to integer precision) when the number of BVs is one.

### <BVP Candidate List>

As described above, the BV deriving part 205A may configure BVP candidate lists for the number of BVs held by a decoding target block.

By giving the examples of L0 list and L1 list again, the examples are categorized into a case of using only a single list (L0 list) and a case of using a plurality of lists (for example, L0 list and L1 list when the BV deriving part 205A derives up to two BVs).

In both cases, the BV deriving part 205A may configure BVP candidates to register to a BVP candidate list(s) with BVs of neighboring blocks of a decoding target block as those illustrated in FIG. 5, BVs used in the past, the average of BVs, or the like.

Alternatively, the BV deriving part 205A may configure BVP candidates to register to a BVP candidate list(s) with BVs derived by IntraTMP disclosed in NPL 2.

The order of registering BVP candidates to be registered in these BVP candidate lists may conform to the registration orders disclosed in NPLs 1 and 2.

Note that the BV deriving part 205A searches for and registers the above-described BVP candidates until the BVP candidate list(s) is filled up with the BVP candidates.

As another example, the BV deriving part 205A may check whether or not BVP candidates exceeding the maximum number of BVP candidates possible to be registered to the BVP candidate list(s) are usable and select BVP candidates to register to the BVP candidate list(s) from among the candidates.

For example, the BV deriving part 205A may register the BVP candidates to the BVP candidate list(s) in the searching order for the BVP candidate list, or may reorder BVP candidates possible to be registered in a reordering method to be described below, for registration.

The maximum number of BVP candidates may be configured at a fixed value or may be adoptively configured according to control information in units of sequence, units of picture, or units of slice to be described below.

The BV deriving part 205A may configure BVP candidate lists of IBC BVP, IBC merge, IBC BVP/merge in common or not in common (use different BVP candidate lists for IBC BVP, IBC merge, and IBC BVP/merge).

As an example of the former case, for example, the BV deriving part 205A may configure the same maximum number of BVP candidates possible to be registered to a BVP candidate list for deriving a BVP (BV) by using an IBC merge index in IBC merge and IBC BVP/merge, for the maximum number of BVP candidates possible to be registered to a BVP candidate list for deriving a BVP by using an IBC BVP flag or an IBC BVP index in IBC BVP and IBC BVP/merge.

By configuring a common BVP candidate list as described above, the circuit size of the image decoding device 200 can be reduced.

As an example of the latter case, for example, the BV deriving part 205A may configure a larger maximum number of BVP candidates (IBC merge candidates) possible to be registered to a BVP candidate list (merge candidate list) for deriving a BVP (merge candidate or BV) by using an IBC merge index in IBC merge and IBC BVP/merge, for the maximum number of BVP candidates possible to be registered to a BVP candidate list for deriving a BVP by using an IBC BVP flag or an IBC BVP index in IBC BVP and IBC BVP/merge.

For example, as in NPL 2, the BV deriving part 205A may fix the maximum value of the number of BVP candidates possible to be registered to a BVP candidate list at two and configure the maximum value of the number of merge candidates possible to be registered to a merge candidate list at six.

In this way, by configuring a larger maximum value of the number of merge candidates possible to be registered to a merge candidate list than that for a BVD candidate list, the number of patterns of a BV possible to be decoded increases, and hence improvement in coding efficiency can be expected.

In a case of checking whether or not a BV such as a neighboring block is usable, to search for a BVP candidate (or merge candidate) possible to be registered to a BVP candidate list (or a merge candidate list), when a BV for which whether or not to be usable is newly checked is the same as a BVP candidate (or merge candidate) already checked to be usable, the BV deriving part 205A may determine (prune) the BV for which whether or not to be usable is newly checked, not to be usable.

By the BV deriving part 205A preventing two or more BVP candidates completely identical to each other in the BVP candidate list from being registered to a BVP candidate list, coding efficiency of control information related to a BVP for selecting a BVP from the BVP candidate list can be improved.

When the pixel precision of a BV eventually derived with application of AMVR or the like for changing the pixel precision of a BV to a decoding target block is larger than that of a case where AMVR or the like is not applied, the BV deriving part 205A may round the pixel precision of a BVP candidate extracted from a neighboring block or the like of the decoding target block for determining usability for the BVP candidate list, at the pixel precision of the BV eventually derived, to determine the usability.

For example, when each BV (1-pixel precision) of a neighboring block extracted for determination of usability for a BVP candidate list is eventually rounded at 4-pixel precision by AMVR or the like, the BV deriving part 205A may round each BV in the BVP candidate list at 4-pixel precision to determine the usability.

When two or more BVP candidate lists (or merge candidate lists) are used for BV derivation, and the pixel precision of a BVP candidate (or merge candidate) in at least one of the lists is rounded by AMVR or the like, the BV deriving part 205A may round the pixel precision of a BVP candidate (or merge candidate) of the other list(s) similarly (at the same pixel precision) and construct the BVP candidate list(s) (or merge candidate list(s)).

As another example, when two or more BVP candidate lists (or merge candidate lists) are used for BV derivation, and the pixel precision of a BVP candidate (or merge candidate) in at least one of the lists is rounded by AMVR or the like, the BV deriving part 205A may construct, without rounding the pixel precisions of BVP candidates (or merge candidates) of the other list(s), the at least one BVP candidate list (or merge candidate list).

For example, since AMVR is a technique for reducing the code amount of a BVD with a coarse pixel precision of a BVD necessary for BV derivation of IBC, the pixel precision of a BVP, eventually a BV, derived in the above-described method of deriving an IBC BVP BV in IBC BVP or IBC BVP/merge being rounded to the pixel precision of the BVD is natural when both IBC and AMVR are applied.

In contrast, the pixel precision of a BVP (or merge candidate), eventually a BV, derived by the method of deriving an IBC merge BV in IBC BVP/merge may be or may not be rounded at the pixel precision of a BVD.

Hence, when AMVR or the like is applied to a decoding target block, for IBC BVP/merge, the BV deriving part 205A may round the pixel precision of each BVP candidate possible to be registered to a BVP candidate list in IBC BVP/merge and determine whether or not to use the BVP candidate, but may determine whether or not to use the BVP candidate without rounding the pixel precision of the BVP candidate (or merge candidate) possible to be registered to a merge candidate list.

The BV deriving part 205A may reorder registering BVP candidates in the BVP candidate list, in a certain reordering method.

Specifically, the BV deriving part 205A uses a neighboring pixel of a decoding block as a template to evaluate the similarity with a neighboring pixel of a reference block referred for the BV of each BVP candidate (the same size as that of the template of the decoding target block), and reorder the BVP candidates in the BVP candidate list in the descending order of similarity.

Here, the BV deriving part 205A may use the sum of squared error (SSE), the sum of absolute difference (SAD), or the like to evaluate the similarity of the template.

Alternatively, the BV deriving part 205A can use the similarity of blocks referred for a BV for reordering of the BVP candidates in the BVP candidate list.

The BV deriving part 205A can use the sum of absolute Hadamard transformed difference (Sum of Absolute Transformed Difference (SATD)) or the like for the similarity.

When the BV deriving part 205A uses a plurality of lists such as L0 list and L1 list, the BV deriving part 205A may blend neighborings of the blocks referred for both of the lists to evaluate the similarity.

Note that the range of reordering of registration BVs to be registered to a BVP list may correspond to all or a limited part of the usable BVP candidates.

By the BV deriving part 205A registering BVP candidates in a BVP candidate list in the descending order of similarity described above, a highly precise BVP can be derived from the BVP candidate list, and consequently, higher precision of second intra-frame prediction, eventually improvement of coding efficiency, can be expected.

### <Refinement>

The BV deriving part 205A may refine the reference location of a BVP derived by IBC BVP, a BVP (BV) derived by IBC merge, or a BVP (BV) derived by IBC BVP/merge described above, in a certain method.

Examples of the certain method is broadly categorized into a method of adding a BVD as a refinement block vector to the derived BVP (BV) and a method of searching for a new reference location based on the BVP (BV) without adding a BVD in a certain searching method to be described below.

The BV deriving part 205A may apply the former method of refining a BV (BVD addition method below) only to the BVP (BV) associated with the IBC merge index of IBC merge or IBC BVP/merge without applying this to IBC BVP, in consideration of the characteristics that a new BVD is added.

The BV deriving part 205A may apply the latter method of refining a BV (BV searching method below), which is a method of not adding a BVD, to any of IBC BVP, IBC merge, and IBC BVP/merge.

As an example of the BVD addition method, the BV deriving part 205A may apply merge mode with block vector difference (MBVD) disclosed in NPL 2.

Concretely, when MBVD is applied, the BV deriving part 205A derives (specifies) a value of a refinement block vector, based on control information.

When MBVD is applied, the BV deriving part 205A may configure a restriction on a possible value of a refinement block vector (reference location) to suppress a code amount of a refinement block vector.

For example, when MBVD is applied, the BV deriving part 205A may limit the distance and the direction of the possible value of a refinement block vector (reference location) to respective discrete values. For example, when MBVD is applied, the BV deriving part 205A may limit the distance of the possible value of a refinement block vector (reference location) to the power of 2 and/or may limit the possible value of a refinement block vector (reference location) to values above, below, left, and right of the possible value.

Note that the decoding part 201 and the BV deriving part 205A may control whether to include candidates for a refinement block vector of decimal pixel precision in candidates for a refinement block vector in MBVD (or whether to include only integer pixels) by control information in units of sequence and/or units of picture and/or units of slice.

Alternatively, the BV deriving part 205A may configure a restriction on a value of a refinement block vector (reference location) according to the number of block vectors held by a decoding target block.

For example, when the decoding target block holds two or more block vectors, the BV deriving part 205A may restrict the value of a refinement block vector (reference location) only to an integer pixel precision.

As another example, the BV deriving part 205A may perform control by control information for determining whether to enable derivation of a plurality of BVs in IBC, in units of sequence and/or units of picture and/or units of slice.

As an example of the BVD addition method, the BV deriving part 205A may apply template matching disclosed in NPL 2.

Template matching is a method of searching for a reference location of a new BVP (BV) while checking the similarity with each neighboring pixel of a reference block based on a derived BVP (BV) by using a neighboring pixel of a decoding target block as a template similarly to the above-described method of reordering BVP candidates.

The BV deriving part 205A may limit the range of the searching to a size similar to that in NPL 2 (for example, the range of 8 pixels in the upper, lower, left, and right directions based on the BVP (BV)).

The BV deriving part 205A may adoptively limit the pixel precision for searching, in consideration of the above-described pixel precision selected for IBC by AMVR or the like (for example, when 1-pixel precision is selected by AMVR or the like, the pixel precision for searching by template matching may also be matched to 1-pixel precision).

As another example of the BVD addition method, when two or more derived BVs are present, the BV deriving part 205A may apply a BV searching technique such as decoder-side motion vector refinement (DMVR) in NPL 1, i.e., decoder-side block vector refinement (DBVR).

Specifically, the BV deriving part 205A applies a group of refinement block vector candidates configured in advance in two or more derived BVPs (BVs) and searches for a refinement block vector having a high similarity between a plurality of reference blocks, to refine BVs (BVPs).

Here, the BV deriving part 205A can use the sum of squared error (SSE), the sum of absolute difference (SAD), or the sum of absolute Hadamard transformed difference (SATD) that are described above, or the like for calculation of similarity in DBVR. DBVR assumes a searching method using two or more BVs and is hence not applied in a case of deriving one BV.

### <Storing>

The BV deriving part 205A stores one or more BVs derived for a decoding target block and a reference image in a memory of the image decoding device 200 in units of certain pixels so that a subsequent decoding target block can refer to.

By the BV deriving part 205A storing the BV(s) derived for the decoding target block and the reference image in the memory, the BV deriving part 205A can use the BV(s) and the reference image of the decoding target block to apply IBC to another decoding target block to be decoded later than the decoding target block, which can increase the rate of application of IBC and improve coding efficiency.

The BV deriving part 205A may store, in the memory, the one or more BVs derived for the decoding target block and the reference image, by using, as units of certain pixels, a 4×4-pixel subblock obtained by subdividing the decoding target block in units of 4×4-pixels as in NPL 1, for example.

Alternatively, the BV deriving part 205A may store, in the memory, the one or more BVs derived for the decoding target block and the reference image in units of a smaller number of pixels or larger number of pixels (power of 2 or 4) than those of a 4×4-pixel subblock. The BV deriving part 205A may store, in the memory, one or more BVs derived for the decoding target block and the reference image according to the number of block vector candidate lists.

For example, when one BV is derived, the BV deriving part 205A stores the BV and a corresponding reference image in L0 list used in normal inter-frame prediction.

When two BVs are derived, the BV deriving part 205A stores the respective BVs and respective corresponding reference images in L0 list and L1 list used in normal inter-frame prediction.

Further, when three or more BVs are derived, the BV deriving part 205A adds Ln list to L0 list and L1 list used for normal inter-frame prediction and stores the respective BVs and respective corresponding reference images in L0 list, L1 list, and Ln list.

When another decoding target block refers to a BV(s) stored in the memory as described above, as a BVP candidate(s), the BV deriving part 205A deploys the BV(s) as a BVP candidate(s) available for a BVP candidate list as follows.

When one BV is stored in the memory, the BV deriving part 205A deploys the BV as one list number for a BVP candidate (one BVP candidate).

In contrast, when two or more BVs are stored in the memory, the BV deriving part 205A deploys the BVs as two or more list numbers (two or more BVP candidates).

The BV deriving part 205A may store the one or more BVs derived for the decoding target block and the reference images in another memory (history below) of a first in first out (FIFO) type, to refer to BVs used in the past described above in history BVP or history BV merge.

Here, when one BV is derived, the BV deriving part 205A directly stores the BV and a corresponding reference image in the history. Note that the BV deriving part 205A does not store the BV when the same BV is already present in the history.

In contrast, when two or more BVs are derived, the BV deriving part 205A stores the two or more BVs and corresponding reference images in the history. Note that the BV deriving part 205A does not register the BVs when the same BVs are already present in the history as in the case of one BV is derived.

Note that, when the BV(s) stored in the memory or history above is refined as described above, the BV deriving part 205A may store a BV(s) after refinement or can store a BV(s) before refinement.

In this case, by the BV deriving part 205A having determined in advance whether to register the BV(s) after refinement or the BV(s) before refinement, effects of being able to omit a sign expressing before or after refinement can be obtained.

In contrast, by the BV deriving part 205A adoptively determining whether to register the BV(s) after refinement or the BV(s) before refinement, effects of being able to improve coding efficiency can be obtained.

### <Blend>

The second intra-frame predicted pixel generating part 205B is configured to blend a predicted pixel of a decoding target block by using a pixel(s) of a reference block(s) referred for one or a plurality of BVs (reference pixel(s)), to generate a second predicted pixel.

In a case of one BV, the second intra-frame predicted pixel generating part 205B may directly use the reference pixel of a reference block as a predicted pixel of the decoding target block or refine the pixel of the reference block.

For example, the second intra-frame predicted pixel generating part 205B may perform the refinement according to a polynomial using the above-described reference pixel.

Specifically, the second intra-frame predicted pixel generating part 205B may be configured to generate refined value P(x, y) as a predicted pixel at coordinates (x, y) in the decoding target block according to the polynomial (refer to the equation below) defined by using reference pixel Q(x, y) described above and weighting factors C1 and C2.

$$P ( x , y ) = C 1 \times Q ( x , y ) + C 2$$

Alternatively, the second intra-frame predicted pixel generating part 205B may use a plurality of reference pixels Q1, Q2, . . . , Qn in a block referred for one BV for one predicted pixel, to define the above polynomial.

The following equation is an example that a polynomial is defined by a 3×3 region with coordinates (x, y) as the center.

$$P ( x , y ) = C 1 \times Q ( x - 1 , y - 1 ) + C 2 \times Q ( x , y - 1 ) + C 3 \times Q ( x + 1 , y - 1 ) + C 4 \times Q ( x - 1 , y ) + C 5 \times Q ( x , y ) + C 6 \times Q ( x + 1 , y ) + C 7 \times Q ( x - 1 , y + 1 ) + C 8 \times Q ( x , y + 1 ) + C 9 \times Q ( x + 1 , y + 1 ) + C 10$$

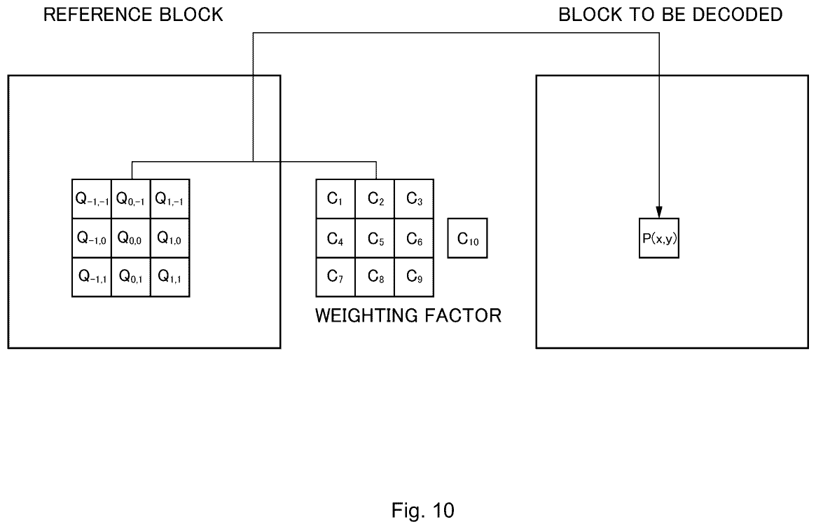

FIG. 10 illustrates an example with 10 weighting factors. Note that Q(x+i, y+j) is expressed by Q_{i,j} to simplify expression.

When a plurality of reference pixels are used to define a polynomial, the second intra-frame predicted pixel generating part 205B preferably uses neighboring pixels.

Alternatively, the second intra-frame predicted pixel generating part 205B may define a plurality of polynomials, based on the distribution of the above-described reference pixels.

The following equations are examples of polynomials having two kinds of coefficients defined with threshold Th when the histogram of reference pixels is bimodal.

$$P ( x , y ) = C 1 \times Q ( x , y ) + C 2 , P ( x , y ) > Th \\ P ( x , y ) = C 3 \times Q ( x , y ) + C 4 , P ( x , y ) \leq Th$$

Here, the second intra-frame predicted pixel generating part 205B may configure a value that separates two modes for the threshold. Alternatively, the second intra-frame predicted pixel generating part 205B can use an average value obtained by simplification, for the threshold.

The second intra-frame predicted pixel generating part 205B can also apply a polynomial having more kinds of coefficients, if the distribution of the above-described reference pixels is multi-modal.

The second intra-frame predicted pixel generating part 205B may be configured to, when a decoding target block has two BVs, weighted-average pixels of two reference blocks (reference pixels) referred for the BVs by using certain weighting values, to generate a second predicted pixel.

For example, the second intra-frame predicted pixel generating part 205B may be configured to simply average reference pixels referred for two or more BVs of the decoding target block at 1:1, to generate a second predicted pixel.

In other words, the second intra-frame predicted pixel generating part 205B may fix the above-described certain weighting values to 1:1 or may configure the certain weighting values adoptively.

When the above-described certain weighting values are adoptively configured, the second intra-frame predicted pixel generating part 205B can configure weighting values which are not 1:1, based on the lengths of BVs, evaluation of similarity between the decoding target block and a neighboring pixel (template) of each reference block.

Here, by performing simple average using 1:1 for the certain weighting values, effects of reducing processing load can be obtained. In contrast, by configuring the certain weighting values adoptively, effects of being able to improve coding efficiency can be obtained.

It is considered that a reference block having a length of BV being small among the plurality of BVs has a small difference from the decoding target block. Hence, prediction precision of a case where a predicted pixel based on two or more BVs is generated can be improved by increasing the weight for a reference block with a BV having a smaller length.

It is considered that a reference block having high similarity (small template cost) in similarity evaluation for template has a small difference from the decoding target block. Hence, prediction precision of a case where a predicted pixel based on two or more BVs is generated can be improved by increasing the weight for a reference block with a BV having a smaller length.

As another example, as bi-directional coding block-based weighted average (bidirectional with CU based weighting (BCW)) disclosed in NPL 1 and NPL 2, the second intra-frame predicted pixel generating part 205B may weighted-average reference pixels of reference blocks referred for two BVs, according to pieces of control information (BCW indices below) each specifying corresponding weighting values to be used in weighted average.

The decoding part 201 may decode the BCW index for bi-directional IBC BVP (or IBC BVP/merge), or may inherit the BCW index held by merge candidates in a merge candidate list without decoding the BCW index for bi-directional IBC merge (or IBC BVP/merge).

Further, the second intra-frame predicted pixel generating part 205B may refine BCW weighting values corresponding to the value of a inherited BCW index, by similarity evaluation using a template for a decoding target block and reference blocks described above, as in NPL 2.

Alternatively, the second intra-frame predicted pixel generating part 205B may be configured to generate a second predicted pixels according to a polynomial defined by using pixels of a plurality of reference destinations.

Specifically, the second intra-frame predicted pixel generating part 205B may be configured to generate refined value P (x, y) as the predicted pixel at coordinates (x, y) in the decoding target block according to a polynomial (refer to the equation below) defined by using a plurality of different reference pixels Q (x, y) and R (x, y) and weighting factors C1, C2, and C3.

$$P ( x , y ) = C 1 \times Q ( x , y ) + C 2 \times P ( x , y ) + C 3$$

According to the above-described configuration, by simplifying a polynomial, effects of reducing calculation load can be obtained. In contrast, by complicating a polynomial, effects of improving prediction precision can be obtained.

The second intra-frame predicted pixel generating part 205B may be configured to define a plurality of polynomials for the above-described polynomial in advance, to enable selection. According to the configuration, a suitable polynomial can be used, and effects of improving coding efficiency can be obtained.

The second intra-frame predicted pixel generating part 205B may be configured to derive coefficients (weighting factors) of the polynomial described above from a neighboring pixel of the decoding target block and a neighboring pixel of a reference block.

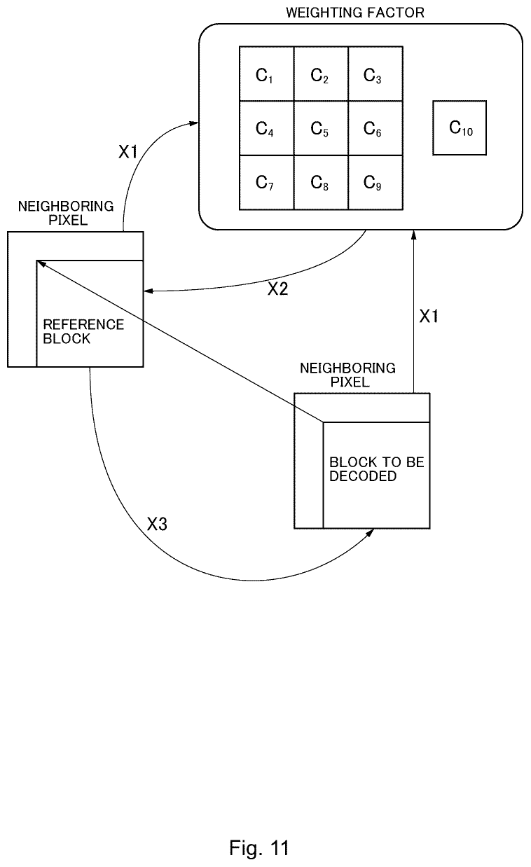

Specifically, as illustrated in FIG. 11, the second intra-frame predicted pixel generating part 205B derives the weighting factors C so that neighboring pixel P′ of a decoding target block and neighboring pixel Q′ of a reference block match as a result of refinement (refer to X1 in FIG. 11).

For example, the second intra-frame predicted pixel generating part 205B defines error function E expressed in the following equation to derive weighting factors C that minimizes E.

$$E = \sum {( {P}^{′} ( x , y ) - ( C 1 \times {Q}^{′} ( x - 1 , y - 1 ) + C 2 \times {Q}^{′} ( x , y - 1 ) + C 3 \times {Q}^{′} ( x + 1 , y - 1 ) + C 4 \times {Q}^{′} ( x - 1 , y ) + C 5 \times {Q}^{′} ( x , y ) + C 6 \times {Q}^{′} ( x + 1 , y ) + C 7 \times {Q}^{′} ( x - 1 , y + 1 ) + C 8 \times {Q}^{′} ( x , y + 1 ) + C 9 \times {Q}^{′} ( x + 1 , y + 1 ) + C 10 ) )}^{2}$$

The second intra-frame predicted pixel generating part 205B can use the least square method or the like for derivation of the weighting factors.

Alternatively, for the purpose of reducing an influence of outliers, the second intra-frame predicted pixel generating part 205B can use robust estimation such as main component regression or partial least square regression to derive the weighting values.

The second intra-frame predicted pixel generating part 205B applies derived weighting factors C to the neighboring pixel Q of the reference block to obtain refined value P (X2 in FIG. 11) and use refined value P as the predicted pixel of the decoding target block (second predicted pixel) (X3 in FIG. 11).

According to the configuration, by deriving the weighting factors from a neighboring pixel, the weighting factors need not be decoded. Hence, effects of improving coding efficiency can be obtained compared to a case where the weighting factors are held as control information.

Applying weighting factors to a plurality of reference pixels corresponds to adoptive derivation of a BV at more detailed decimal precision. Hence, effects of improving coding efficiency by reduction of the code amount for the BV can be obtained.

Here, the second intra-frame predicted pixel generating part 205B may be configured to use neighboring pixels P′ and Q′ within a certain range for derivation of the above-described weighting factors (coefficients of a polynomial).

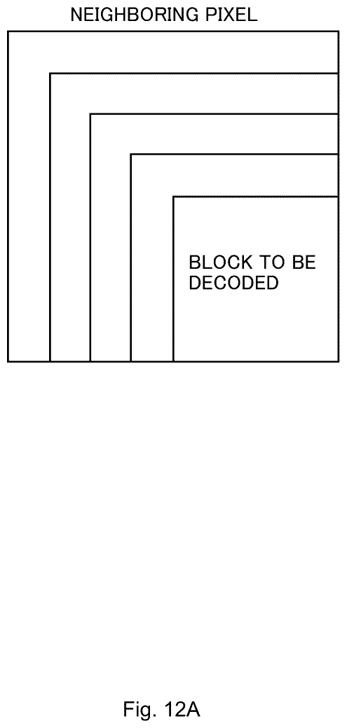

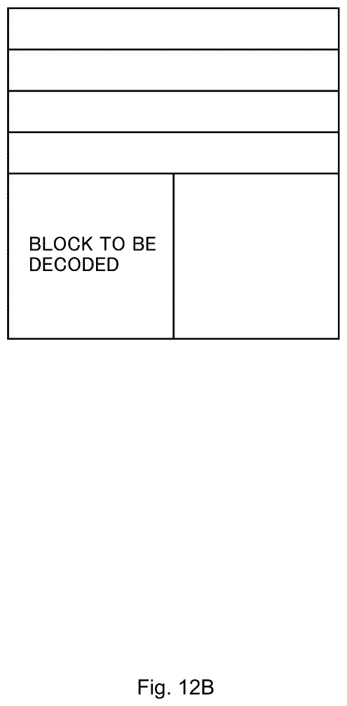

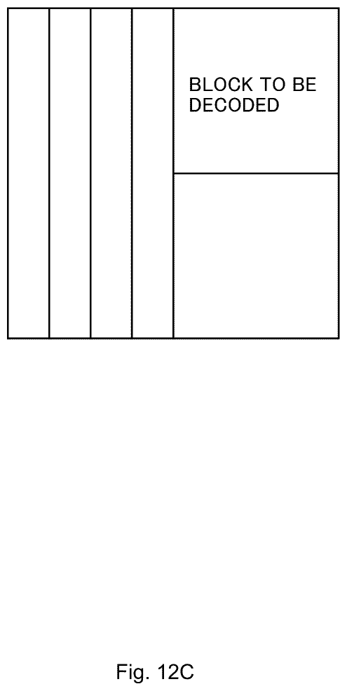

For example, as illustrated in FIG. 12A, the second intra-frame predicted pixel generating part 205B may be configured to use neighboring pixels within four pixel lines from a decoding target block for derivation of the above-described weighting factors (coefficients of a polynomial).

In contrast, the second intra-frame predicted pixel generating part 205B may limit neighboring pixels to be used for derivation of weighting factors described above.

For example, the second intra-frame predicted pixel generating part 205B may use only neighboring pixels in a region located above the decoding target block as illustrated in FIG. 12B for derivation of weighting factors or may use only neighboring pixels in a region located on the left of the decoding target block as illustrated in FIG. 12C for derivation of weighting factors.

Note that the second intra-frame predicted pixel generating part 205B may be configured to be able to select a plurality of ranges for specifying neighboring pixels described above. According to the configuration, suitable weighting factors can be derived, and effects of improving coding efficiency can be obtained.

### (Basic Concept of IBC OBMC)

The second intra-frame predicted pixel generating part 205B may calculate weighted average of a reference pixel of a reference block of a decoding target block and a neighboring pixel of a reference block of an adjacent block, instead of a reference pixel of the decoding target block itself, to perform refinement on the reference pixel of the reference block of the decoding target block.

Consequently, as in overlapped block motion compensation (OBMC) for an inter-frame predicting means disclosed in NPL 2, effects of smoothly connecting the block boundary between a predicted block generated by IBC and an adjacent block adjacent to the predicted block can be obtained.

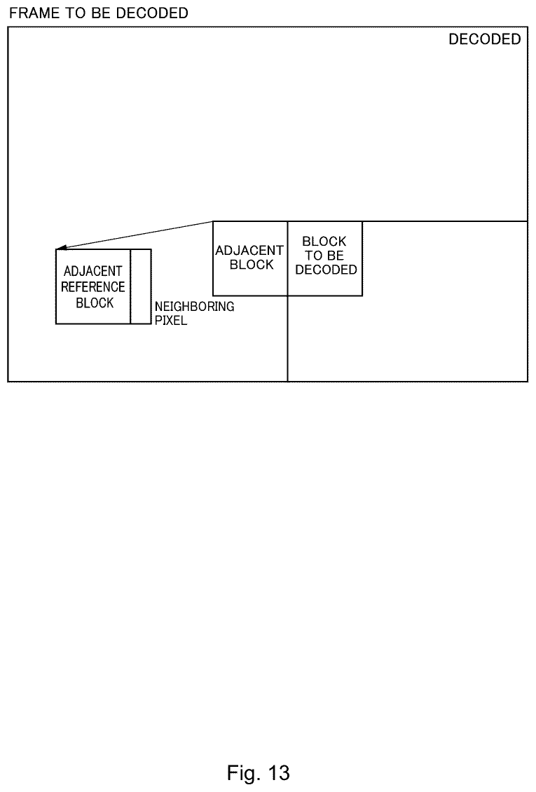

FIG. 13 illustrates a case where an adjacent block of a decoding target block has a BV. As illustrated in FIG. 13, first, the second intra-frame predicted pixel generating part 205B acquires a neighboring pixel corresponding to a relative location of the decoding target block, in an adjacent reference block referred for the BV of the adjacent block (adjacent reference neighboring pixel below).

In the example in FIG. 13, since the adjacent block is located on the left of the decoding target block, the second intra-frame predicted pixel generating part 205B acquires an adjacent reference neighboring pixel on the right of the adjacent reference block.

The range for the adjacent reference neighboring pixel may be configured fixedly or may be configured variably.

For example, the second intra-frame predicted pixel generating part 205B may change the range for the adjacent reference neighboring pixel according to block size and an aspect ratio.

Secondly, the second intra-frame predicted pixel generating part 205B calculates weighted average of the adjacent reference neighboring pixel and a reference pixel of the decoding target block. In the following, the processing is referred to as “IBC OBMC”.

### (Application Determination and Application Processing Unit of IBC OBMC)

The second intra-frame predicted pixel generating part 205B may determine whether or not to apply IBC OBMC in units of decoding target block, may determine this in units of block (subblock below) smaller than the decoding target block in a decoding target block, or may determine this at two stages in units of decoding block and units of subblock.

As disclosed in NPL 2, as an example of determination in units of subblock, the second intra-frame predicted pixel generating part 205B may determine whether or not to apply IBC OBMC per subblock of 4×4 pixels sharing the block boundary with the left portion and the upper portion of the decoding target block.

By determining whether or not to apply IBC OBMC in units of decoding target block as described above, an increase of a processing amount necessary for the determination can be suppressed.

In contrast, by determining whether or not to apply IBC OBMC in units of subblock, when IBC is applied to a decoding target block, IBC OBMC can be applied where IBC OBMC is valid in the decoding target block. Hence, prediction precision improves.

The second intra-frame predicted pixel generating part 205B may apply IBC OBMC in units of block (subblock below) smaller than the decoding target block in a decoding target block, based on a result of determination of whether or not to apply IBC OBMC.

### (Application Condition of IBC OBMC)

When a certain condition is satisfied in units of decoding target block and/or units of subblock, the second intra-frame predicted pixel generating part 205B may determine to apply IBC OBMC. When the certain condition is not satisfied, the second intra-frame predicted pixel generating part 205B may determine not to apply IBC OBMC.

The second intra-frame predicted pixel generating part 205B may configure the certain condition from at least one of the conditions given below.
1. Control information (IBC OBMC flag) indicating that IBC OBMC is applicable in units of sequence and/or picture and/or slice is enabled.
2. Control information (IBC OBMC flag) indicating that IBC OBMC is applicable in units of decoding target block is enabled.
3. The area (number of pixels) of a decoding target block is 32 pixels or more.
*Here, for condition 3, 16 pixels, 64 pixels, or 128 pixels may be used instead of 32 pixels.
4. An adjacent block adjacent to a decoding target block (or subblock) has a BV or a motion vector.
5. A BV of a decoding target block (or subblock) and a BV or a motion vector of an adjacent block are different from each other.
6. In a decoding target block, local illumination compensation disclosed in NPL 2 is not applied (is disabled).
7. The largest difference between a reference pixel based on a BV of a decoding target block (or subblock) and the pixel value of a corresponding adjacent reference neighboring pixel based on a BV or a motion vector of an adjacent block is equal to or smaller than a certain threshold.
8. In a gradient histogram for a reference pixel of a decoding target block, main gradient is high.
9. A decoding target block (or subblock) has one BV.
10. An adjacent block of a decoding target block (or subblock) has one BV or motion vector.

Alterations of the above-described certain condition will be described below.

For condition 5 described above, when a reference frame referred for a BV of the decoding target block (or subblock) and a reference frame referred for the BV or the motion vector of the adjacent block are different from each other, the second intra-frame predicted pixel generating part 205B may determine that the BV of the decoding target block (or subblock) and the BV or the motion vector of the adjacent block are different from each other.

For condition 6 and condition 7 described above, the second intra-frame predicted pixel generating part 205B may use a predicted pixel after a reference pixel being subjected to an interpolation filter instead of using the reference pixel itself.

Further, the second intra-frame predicted pixel generating part 205B can configure different application restrictions for IBC OBMC according to the number of derived BVs for the decoding target block (or subblock) or the adjacent block. This is concretely as follows.

The second intra-frame predicted pixel generating part 205B may add a condition that a decoding target block (or subblock) has one BV, to the above-described certain condition.

Only when the decoding target block (or subblock) has one BV, the second intra-frame predicted pixel generating part 205B restricts application of IBC OBMC to thereby be able to suppress an increase of the memory bandwidth for acquiring an adjacent reference neighboring pixels necessary in a case of applying IBC OBMC.

The second intra-frame predicted pixel generating part 205B may add a condition that a neighboring block of a decoding target block (or subblock) has one BV or motion vector, to the above-described certain condition.

Only when the adjacent block of the decoding target block (or subblock) has one BV or motion vector, the second intra-frame predicted pixel generating part 205B restricts application of IBC OBMC to thereby be able to suppress an increase of the memory bandwidth for acquiring an adjacent reference neighboring pixels necessary in a case of applying IBC OBMC.

When the adjacent block of the decoding target block (or subblock) has two or more BVs or motion vectors, the second intra-frame predicted pixel generating part 205B may compare the BVs or the motion vectors of the adjacent block in terms of size or template cost, to select one BV or motion vector.

For example, the second intra-frame predicted pixel generating part 205B may select a BV or motion vector of the adjacent block having the smallest size or lowest template cost of the BV or motion vector of the adjacent block.

Configuring an application condition of IBC OBMC in units of decoding target block and/or units of subblock as those described above has the following aim (expected effects).

For example, an image rendered by CG or a screen image often has clear edges in an original image, and hence is likely to be an image having discontinuous block boundaries. Hence, in such an image, prediction error near a block boundary is easier to be suppressed with no application of IBC OBMC.

The second intra-frame predicted pixel generating part 205B can apply IBC OBMC only in a case of a specific slice or a specific block size.

By restricting application of IBC OBMC according to slice and/or block size as described above, effects of reducing the processing amount of coding can be obtained.

For example, slice-based restriction is applied in IBC, while slice-based limitation is not applied in IntraTMP.

Since IntraTMP has a small processing amount for searching for a BV and low prediction precision compared to those of IBC, effects of improving coding efficiency can be obtained by increasing application targets.

### (Weighted Average of IBC OBMC)

Alternatively, the second intra-frame predicted pixel generating part 205B may apply refinement used for refinement of a reference pixel described above, for a neighboring pixel described above.

The second intra-frame predicted pixel generating part 205B derives weighting factors from all or part of the pixels of an adjacent block and the pixels of an adjacent reference block.

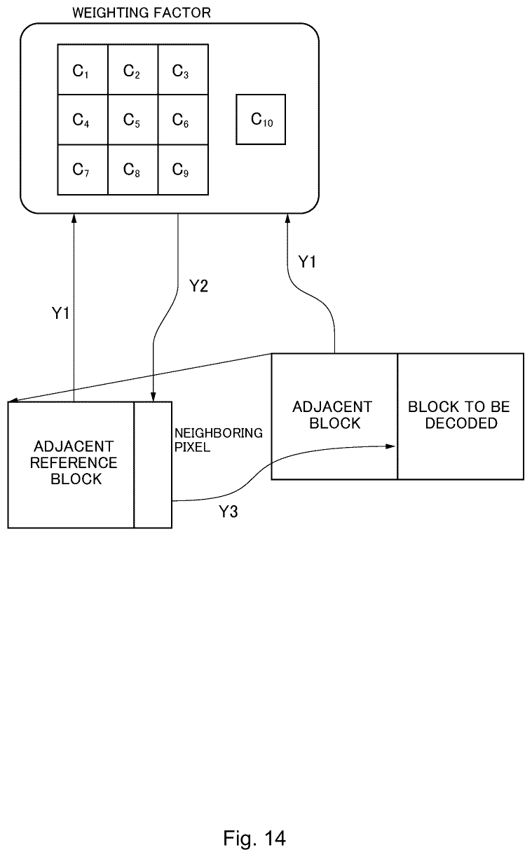

Specifically, as illustrated in FIG. 14, the second intra-frame predicted pixel generating part 205B derives weighting factors C with a pixel of an adjacent block as P′ and a pixel of the adjacent reference block as Q′ (Y1 in FIG. 14), and then apply the weighting factors C to neighboring pixel Q of the adjacent reference block to obtain refined value P (Y2 in FIG. 14) to calculate a predicted pixel and the weighted average of a decoding target block (Y3 in FIG. 14).

According to the configuration, by reflecting a neighboring pixel of an adjacent reference block in a predicted pixel of a decoding target block, prediction error is reduced, and effects of improving coding efficiency can be obtained.

Note that, when the number of BVs is different between a decoding target block and a reference block, the second intra-frame predicted pixel generating part 205B adjusts the number of BVs being larger to the number of BVs being smaller (reduces the numbers of BVs of the decoding target block and the adjacent block to the smallest number of BVs).

Similarly, when pixel precision of a BV is different between a decoding target block and a reference block, the second intra-frame predicted pixel generating part 205B adjusts the pixel precision of the BV being finer to the pixel precision of a BV being coarser (rounds the pixel precisions of BVs of the decoding target block and the adjacent block at the highest pixel precision).

### (IBC GPM)

When IBC GPM is applied to a decoding target block, the second intra-frame predicted pixel generating part 205B may weighted-average a pixel(s) of a reference destination(s) (reference pixel(s)) of one or more BVs for each partitioned region obtained by partitioning into two by a partitioning line of IBC GPM, according to distance from the partitioning line of IBC GPM.

As an alteration, the second intra-frame predicted pixel generating part 205B may fixedly configure the number of pixels for a region subjected to the weighted average, i.e., each partitioned region direction from the partitioning line of IBC GPM, or may be configured adoptively.

As a method of configuring this fixedly, the second intra-frame predicted pixel generating part 205B may configure a value such as 0 pixels, ¼ pixels, ½ pixels, 1 pixel, 2 pixels, 4 pixels, or 8 pixels.

For example, by using a small number of pixels such as 0 pixels or ¼ pixels for the number of pixels of a weighted average region width of IBC GPM for a screen image, a partitioning line of IBC GPM can be applied easily, which can maintain pixel values at an edge boundary unique to a screen image without excessive smoothing. Hence, prediction error can easily be reduced.

As a method of configuring this adoptively, the second intra-frame predicted pixel generating part 205B can apply a method based on GPM adoptive blending disclosed in NPL 2. For example, by configuring, for a natural image, the number of pixels of a weighted average region width of IBC GPM adoptively based on control information or a block size as in adoptive blending method of GPM disclosed in NPL 2, prediction error near a partitioning line of IBC GPM can easily be reduced.

### <Transform>

The inverse transforming part 203 may adoptively select one transform base from a plurality of different transform bases, for a transform coefficient of a decoding target block to which IBC (or IntraTMP) is applied, and apply inverse-transform processing.

Here, as an example of the plurality of different transform bases, the inverse transforming part 203 may use multiple transform bases (multiple transform selection (MTS)) disclosed in NPL 1.

MTS disclosed in NPL 1 includes MTS for intra-frame prediction and MTS for inter-frame prediction.

The inverse transforming part 203 may apply MTS for intra-frame prediction disclosed in NPL 1 or may apply MTS for inter-frame prediction disclosed in NPL 1.

The inverse transforming part 203 may identify a transform base for application from candidates for the transform base in MTS, based on the value of control information for specifying a candidate for the transform base of MTS decoded or inferred by the decoding part 201.

As an alteration, the inverse transforming part 203 may apply 2-stage inverse transform processing using different or the same transform base, to a transform coefficient of a decoding target block to which IBC (or IntraTMP) is applied.

Here, as an example of 2-stage inverse transform processing using different transform bases, the inverse transforming part 203 may use low-frequency non-separable secondary transform (Low-Frequency Non-Separable Transform (LFNST)) disclosed in NPL 1.

The decoding part 201 may select one transform base from among a plurality of different transform bases and decode control information for specifying whether or not to inverse-transform the transform coefficient. The inverse transforming part 203 may identify a transform base for application from among candidates for a transform base in LFNST, based on the value of control information for specifying a candidate for the transform base in LFNST decoded or inferred by the decoding part 201.

A reason for applying MTS or LFNST to a decoding target block to which IBC (or IntraTMP) is applied is as follows.

In IBC (or IntraTMP), a block to which this is applied often has complex image characteristics such as edges and stripes due to the characteristics of signal processing described above. Hence, transform coefficients derived after transform of prediction error of such a decoding target block to which IBC (or IntraTMP) is applied are likely to be distributed in high frequency components or show biases in horizontal components, vertical components, or oblique components.

By adoptively selecting a valid inverse transform base for application from a plurality of different transform bases or applying 2-stage inverse transform using different or the same transform base, for such a distribution of transform coefficients, effects of reducing redundancy between transform coefficients (eventually spatial redundancy in prediction error) can be expected, and consequently improvement of coding efficiency can be expected.

### <Chroma>

In decoding (or coding) of a video, to reduce the amount of information, RGB signals forming the video are converted to luma signals (Y signals) and chroma signals (UV signals or CbCr signals) for decoding (or coding) in some cases.

To further reduce the amount of information, the number of pixels of chroma signals are thinned out (downsampled) at regular intervals (for example, to be half in the horizontal direction and/or vertical direction) with respect to the number of pixels of luma signals in some cases.

Further, NPL 1 discloses a technique (single-tree structure) for making decoding (or coding) tree block partitioning structures in the same decoding (or coding) tree block the same, in a luma-signal image and a chroma-signal image, and a technique (dual-tree structure) changing the partitioning structures.

In a case as the above, for example, when chroma-signal images are downsampled with respect to luma-signal images and also each decoding (or coding) tree block including a decoding target block has a single-tree structure, the BV deriving part 205A may derive a BV(s) for the decoding target block of each chroma signal, based on the size (horizontal component and vertical component) of one or two or more BVs derived for the decoding target block of each luma signal and the downsampling ratio between the luma signals and chroma signals.

More specifically, the BV deriving part 205A may reduce the size (horizontal component and vertical component) of one or two or more BVs derived for the decoding target block of each luma signal according to the downsampling ratio between the luma signals and chroma signals.

Further, in a case as the above, for example, when chroma-signal images are downsampled with respect to luma-signal images and also each decoding (or coding) tree block including a decoding target block has a dual-tree structure, the BV deriving part 205A need not derive any BV for the decoding target block of the chroma signals.

### <Signaling>

Control information (syntax) for the decoding part 201 decoding a mode for holding a BV (BV mode below) will be described below.

Coding information input to the decoding part 201 can include a sequence parameter set (SPS) putting pieces of control information (syntaxes) in units of decoding target sequence together.

The coding information can include a picture parameter set (PPS) putting pieces of control information in units of decoding target picture together or a picture header (PH). Alternatively, the coding information can include a slice header (SH) putting pieces of control information in units of decoding target slice together.

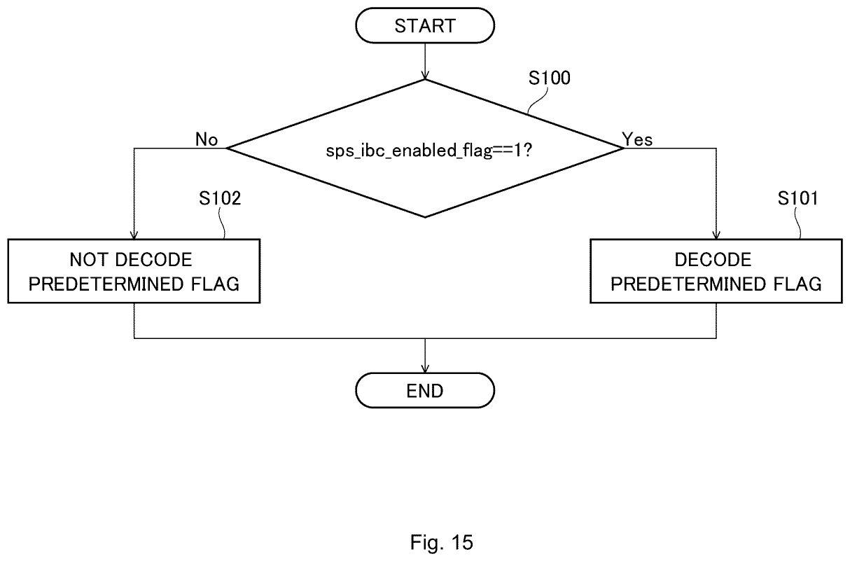

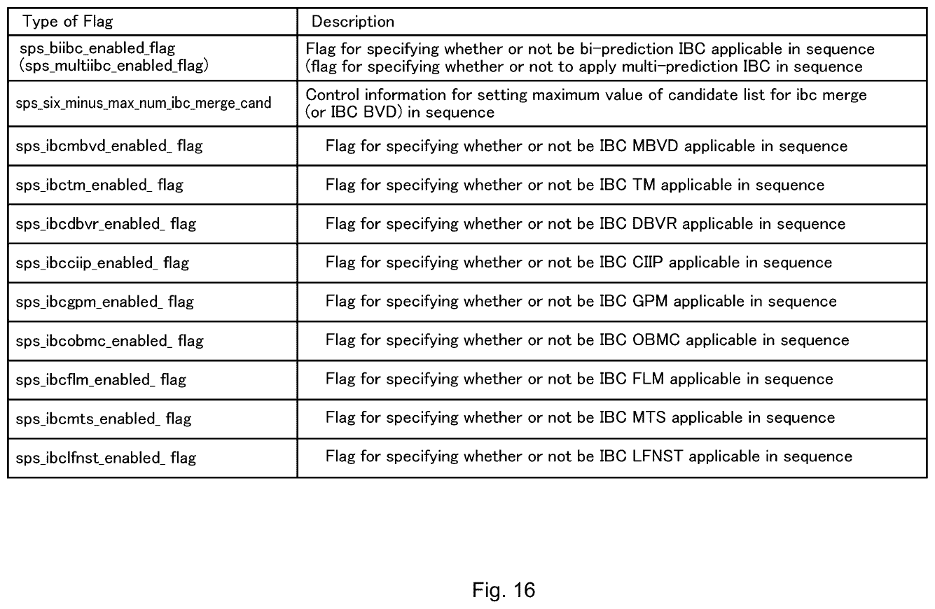

In the following, by using FIG. 15 and FIG. 16, a method of controlling decoding of various flags related to IBC in units of sequence, units of picture, or units of slice in the decoding part 201 and definitions (meanings) of the various flags will be described.

FIG. 15 is a diagram illustrating a method of controlling decoding of a certain flag related to IBC in units of sequence. The decoding part 201 operates concretely as follows.

As illustrated in FIG. 15, in step S100, the decoding part 201 determines whether or not sps_ibc_enabled_flag (second syntax) is 1. If sps_ibc_enabled_flag is 1, this operation advances to step S101. If sps_ibc_enabled_flag is not 1, this operation advances to step S102.

Here, sps_ibc_enabled_flag is a flag for controlling (specifying) whether or not IBC is applicable in units of sequence. The decoding part 201 identifies that IBC is applicable when sps_ibc_enabled_flag is 1 while identifying that IBC is not applicable when sps_ibc_enabled_flag is 0.

The decoding part 201 decodes a certain flag in step S101 while not decoding the certain flag in step S102, and then terminates this processing.

Here, the decoding part 201 may decode any of various flags related to IBC as those illustrated in FIG. 16, as the certain flag. This is concretely as follows.

sps_biibc_enabled_flag illustrated in FIG. 16 is a flag (first syntax) for controlling (specifying) whether or not bi-prediction IBC is applicable in units of sequence. The decoding part 201 identifies that bi-prediction IBC is applicable when sps_biibc_enabled_flag is 1 while identifying that bi-prediction IBC is not applicable when sps_biibc_enabled_flag is 0.

The decoding part 201 may decode sps_multiibc_enabled_flag as an alteration of sps_biibc_enabled_flag.

sps_multiibc_enabled_flag is a flag for controlling (specifying) whether or not multi-prediction IBC is applicable in units of sequence. The decoding part 201 identifies that multi-prediction IBC is applicable when sps_multiibc_enabled_flag is 1 while identifying that multi-prediction IBC is not applicable when sps_multiibc_enabled_flag is 0.

sps_ibcmbvd_enabled_flag illustrated in FIG. 16 is a flag for controlling (specifying) whether or not IBC MBVD is applicable in units of sequence. The decoding part 201 identifies that IBC MBVD is applicable when sps_ibcmbvd_enabled_flag is 1 while identifying that IBC MBVD is not applicable when sps_ibcmbvd_enabled_flag is 0.

sps_six_minus_max_num_ibc_merge_cand illustrated in FIG. 16 is control information for configuring a maximum value of a candidate list of IBC merge (or IBC BVP) described above in units of sequence.

For example, when the maximum value at which a candidate list of IBC merge (or IBC BVP) designed by the image decoding device 200 can be configured is six (corresponding to “six” in sps_six_minus_max_num_ibc_merge_cand), the maximum value can be changed by using the control information.

Specifically, the decoding part 201 may control (change the configuration) of the maximum value of a candidate list of IBC merge (or IBC BVP) of the image decoding device 200 in units of sequence as below.

if (sps_ibc_enabled_flag)
MaxNumIbcMergeCand = 6 −
sps_six_minus_max_num_ibc_merge_cand
else
MaxNumIbcMergeCand = 0

Here, MaxNumIbcMergeCand is an internal parameter of a decoding device expressing the maximum value of a block vector candidate list for deriving one or more block vectors to be used for IBC merge (or IBC BVP) configured in units of sequence (or picture, slice, or decoding target block).

sps_ibctm_enabled_flag illustrated in FIG. 16 is a flag for controlling (specifying) whether or not TM for IBC (IBC TM) is applicable in units of sequence. The decoding part 201 identifies that IBC TM is applicable when sps_ibctm_enabled_flag is 1 while identifying that IBC TM is not applicable when sps_ibctm_enabled_flag is 0.

sps_ibcdbvr_enabled_flag illustrated in FIG. 16 is a flag for controlling (specifying) whether or not DBVR for IBC (IBC DBVR) is applicable in units of sequence. The decoding part 201 identifies that IBC DBVR is applicable when sps_ibcdbvr_enabled_flag is 1 while identifying that IBC DBVR is not applicable when sps_ibcdbvr_enabled_flag is 0.

sps_ibcciip_enabled_flag illustrated in FIG. 16 is a flag for controlling (specifying) whether or not combined intra inter prediction (CIIP) for IBC (IBC CIIP) disclosed in NPL 2 is applicable in units of sequence. The decoding part 201 identifies that IBC CIIP is applicable when sps_ibcciip_enabled_flag is 1 while identifying that IBC CIIP is not applicable when sps_ibcciip_enabled_flag is 0.

sps_ibcgpm_enabled_flag illustrated in FIG. 16 is a flag for controlling (specifying) whether or not IBC GPM is applicable in units of sequence. The decoding part 201 identifies that IBC GPM is applicable when sps_ibcgpm_enabled_flag is 1 while identifying that IBC GPM is not applicable when sps_ibcgpm_enabled_flag is 0.

sps_ibcobmc_enabled_flag illustrated in FIG. 16 is a flag for controlling (specifying) whether or not IBC OBMC is applicable in units of sequence. The decoding part 201 identifies that OBMC for IBC (IBC OBMC) is applicable when sps_ibcobmc_enabled_flag is 1 while identifying that IBC OBMC is not applicable when sps_ibcobmc_enabled_flag is 0.

sps_ibcflm_enabled_flag illustrated in FIG. 16 is a flag for controlling (specifying) whether or not application of weighting factors defined in the above-mentioned polynomial for IBC (IBC filtered linear model (IBC FLM)) is applicable in units of sequence. The decoding part 201 identifies that IBC FLM is applicable when sps_ibcflm_enabled_flag is 1 while identifying that IBC FLM is not applicable when sps_ibcflm_enabled_flag is 0.

sps_ibcmts_enabled_flag illustrated in FIG. 16 is a flag for controlling (specifying) whether or not MTS for IBC (IBC MTS) is applicable in units of sequence. The decoding part 201 identifies that IBC MTS is applicable when sps_ibcmts_enabled_flag is 1 while identifying that IBC MTS is not applicable when sps_ibcmts_enabled_flag is 0.

sps_ibclfnst_enabled_flag illustrated in FIG. 16 is a flag for controlling (specifying) whether or not LFNST for IBC (IBC LFNST) is applicable in units of sequence. The decoding part 201 identifies that IBC LFNST is applicable when sps_ibclfnst_enabled_flag is 1 while identifying that IBC FLNST is not applicable when sps_ibclfnst_enabled_flag is 0. When the various flags described above are not decoded, the decoding part 201 may identify that these values are 0.

Here, although the method of controlling decoding of various flags in units of sequence is described in FIG. 15 and FIG. 16, similar control may be performed in a finer unit, i.e., in units of picture or units of slice. Control may be performed only in such a specific level or may be performed in multiple levels over a plurality of levels.

For example, an increase in code amount can be suppressed by configuring control only in a higher level, or adoptive control is enabled by configuring control also in a lower level and prioritizing the configuration in the lower level.

Note that, in the above-described example, a method of configuring a refinement method in units of sequence, units of picture, or units of slice. However, without configuring these, a direct method in units of block to be described below may be selected. In this case, an increase in header information described above can be prevented.

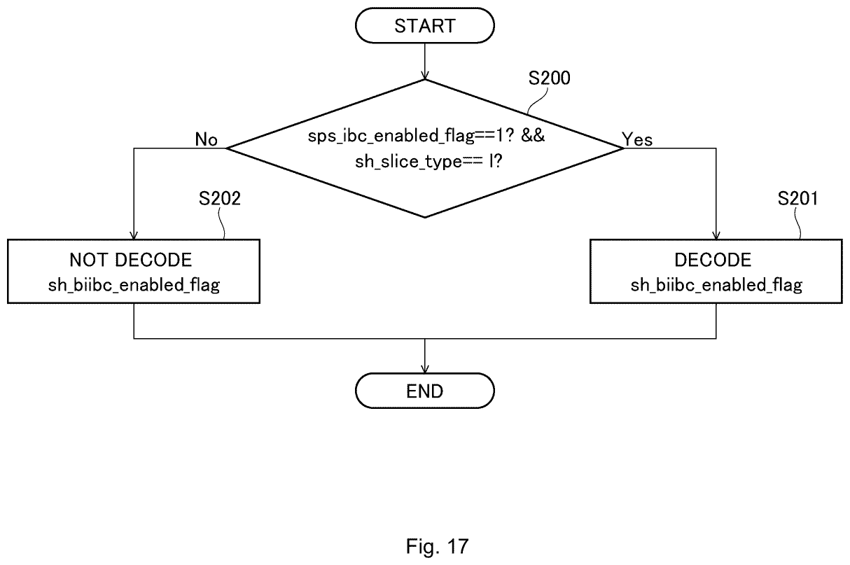

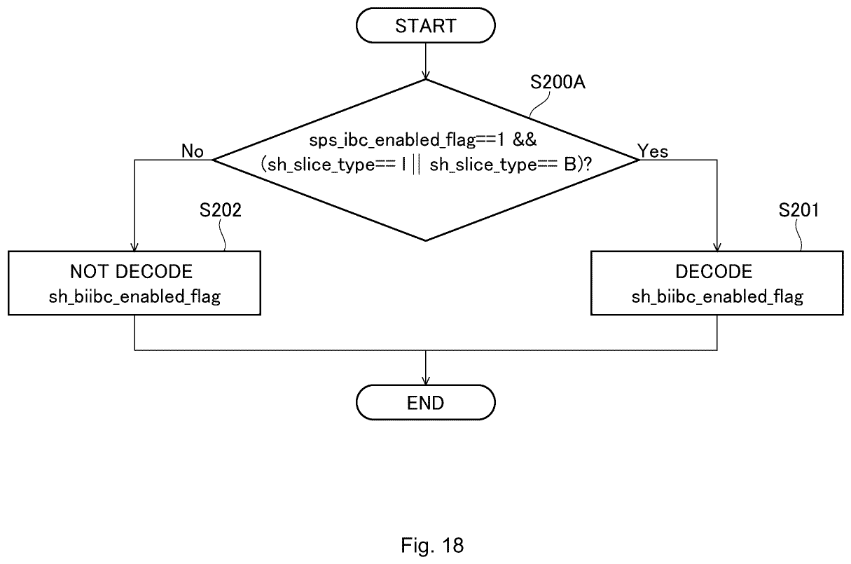

In the following, by using FIG. 17 and FIG. 18, a method of decoding a flag for controlling whether or not IBC using two BVs (bi-prediction IBC) is applicable in units of slice (or units of picture or units of sequence) in the decoding part 201 and definitions (meanings) of the flag will be described.

Note that, although a decoding method taking IBC using two BVs (bi-prediction IBC) as an example will be described in the following, a similar decoding method may be performed with IBC using two BVs being interpreted as IBC using two or more BVs (multi-prediction IBC).

FIG. 17 is a diagram illustrating an example of a method of decoding a flag for controlling (specifying) whether or not bi-prediction IBC is applicable, in the decoding part 201.

In FIG. 17, the decoding part 201 may decode or infer, without decoding, the flag for controlling (specifying) whether or not bi-prediction IBC is applicable, as follows.

As illustrated in FIG. 17, in step S200, the decoding part 201 determines whether or not sps_ibc_enabled_flag is 1 and sh_slice_type is I (is I slice).

If Yes, this operation advances to step S201. If No, this operation advances to step S202.

Here, sh_slice_type is control information (syntax) indicating the type of a slice including a decoding target block in units of slice.

Examples of the type of slice include I slice (slice to which first intra-frame prediction or second intra-frame prediction is applicable), B slice (slice to which first intra-frame prediction, second intra-frame prediction, or inter-frame prediction is applicable), and P slice (slice to which first intra-frame prediction, second intra-frame prediction, or inter-frame prediction is applicable where only uni-prediction is applicable with respect to inter-frame prediction).

In step S201, the decoding part 201 decodes sh_biibc_enabled_flag and terminates this processing.

In step S202, the decoding part 201 does not decode sh_biibc_enabled_flag and terminates this processing.

Here, sh_biibc_enabled_flag (third syntax) is a flag for controlling whether or not to apply bi-prediction IBC in the units of slice.

The decoding part 201 identifies that bi-prediction IBC is applicable when sh_biibc_enabled_flag is 1 while identifying that bi-prediction IBC is not applicable when sh_biibc_enabled_flag is 0.

When sh_biibc_enabled_flag is not decoded, the decoding part 201 may infer the value of sh_biibc_enabled_flag according to the value of sh_slice_type.

Specifically, the decoding part 201 may infer that sh_biibc_enabled_flag is 1 when sh_slice_type is B (is B slice) while inferring that sh_biibc_enabled_flag is 0 when sh_slice_type is P (is P slice).

The decoding part 201 may perform inference of sh_biibc_enabled_flag according to the following equation.

$$sh\_biibc \_enabled \_flag = ( sh\_slice \_type == B ? ) : 1 or 0$$

Here, as described above, a reason for decoding or inferring a flag for controlling whether or not bidirectional IBC is applicable in units of slice is as follows.

I slice has image characteristics for which first intra-frame prediction is valid compared to second intra-frame prediction such as IBC or IntraTMP in some cases. Hence, by controlling whether or not bi-prediction IBC is applicable in units of slice, bi-prediction IBC is determined to be applicable for a slice for which second intra-frame prediction is valid particularly, to improve coding efficiency, while bi-prediction IBC is determined not to be applicable for a slice for which second intra-frame prediction is invalid, to reduce the code amount of control information necessary for bi-prediction IBC to be described below, and consequently, improvement of coding efficiency can be expected.

A reason for inferring that sh_biibc_enabled_flag is 1 without decoding sh_biibc_enabled_flag in B slice is as follows. Normal inter-frame prediction (including biprediction using two motion vectors) is applicable to B slice. Hence, by bi-prediction IBC being regularly applicable, this attempts to configure design in common with normal inter-frame prediction, and also improvement of coding efficiency can be expected.

A reason for inferring that sh_biibc_enabled_flag is 0 without decoding sh_biibc_enabled_flag in P slice is as follows. Bi-prediction is not applicable to P slice in normal inter-frame prediction. Hence, similarly by bi-prediction IBC being not applicable, this attempts to configure design in common with normal inter-frame prediction, and also improvement of coding efficiency can be expected.

FIG. 18 is an alteration of FIG. 17. The difference of FIG. 17 from FIG. 16 is in step S200A.

Concretely, as illustrated in FIG. 18, in step S200A, the decoding part 201 determines whether or not sps_ibc_enabled_flag is 1 and sh_slice_type is I or B (is I slice or B slice).

If Yes, this operation advances to step S201. If No, this operation advances to step S202.

Here, in step S200A, sh_slice_type is B (B slice) being added in addition to sh_slice_type being I (I slice). This enables control of whether or not bi-prediction IBC is applicable in units of slice even when a slice including a decoding target block is B slice. Hence, effects of improving coding efficiency can be expected.

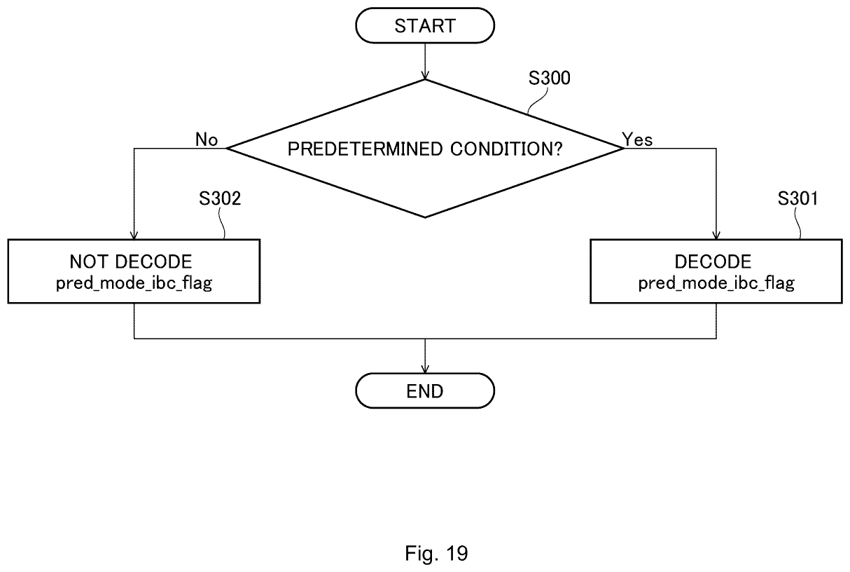

In the following, by using FIG. 19 to FIG. 24, a method of controlling decoding of various flags related to IBC in units of decoding target block (decoding block, prediction block, or transform block) in the decoding part 201 and definitions (meanings) of the various flags will be described.

FIG. 19 is a diagram illustrating an example of a method of decoding pred_mode_ibc_flag, which is a flag for controlling whether or not to apply IBC in units of decoding target block (decoding block, prediction block, or transform block) in the decoding part 201.

Here, the decoding part 201 may identify that IBC is applied in units of decoding target block (decoding block, prediction block, or transform block) when pred_mode_ibc_flag is 1 while identifying that IBC is not applied in units of decoding target block when pred_mode_ibc_flag is 0.

When pred_mode_ibc_flag is not decoded, the decoding part 201 may infer that pred_mode_ibc_flag is 0.

Alternatively, the decoding part 201 may determine whether or not to apply IBC in units of decoding target block (decoding block, prediction block, or transform block) when pred_mode_ibc_flag is 1, further depending on whether or not the decoding target block is a single tree.

Specifically, the decoding part 201 may determine that IBC is applied when the decoding target block is a single tree while determining that IBC is not applied when the decoding target block is a dual tree.

As an alteration, the decoding part 201 may determine that IBC is applied when the decoding target block is a luma block even when being a dual tree.

The decoding part 201 may control whether or not the decoding target block (decoding block, prediction block, or transform block) is IBC, by using CuPredMode, which is an inner parameter indicating a prediction mode of the decoding target block, as in NPL 1.

Concretely, when CuPredMode is MODE_IBC, the decoding part 201 may determine that the decoding target block (decoding block, prediction block, or transform block) is IBC. Otherwise, the decoding part 201 may determine that the decoding target block (decoding block, prediction block, or transform block) is not IBC.

Operation in FIG. 19 will be described below.

As illustrated in FIG. 19, in step S300, the decoding part 201 determines whether a certain condition is satisfied.

If Yes, this operation advances to step S301. If No, this operation advances to step S302.

In step S301, the decoding part 201 decodes pred_mode_ibc_flag and terminates this processing.

In step S302, the decoding part 201 does not decode pred_mode_ibc_flag and terminates this processing.

Here, the certain condition may include at least one condition of the following conditions.
1. The width or height of the decoding target block is not 128 pixels (width or height of the decoding target block is 64 pixels or less).
*Here, the number of pixels being a threshold of condition 1 may be changed to the number of pixels being the power of 2 such as 128 pixels or less, 256 pixels or less, or 32 pixels or less, instead of 64 pixels.
2. Prediction mode of the decoding target block is not inter-frame prediction or first intra-frame prediction.
3. The decoding target block is not a chroma block of a dual tree.

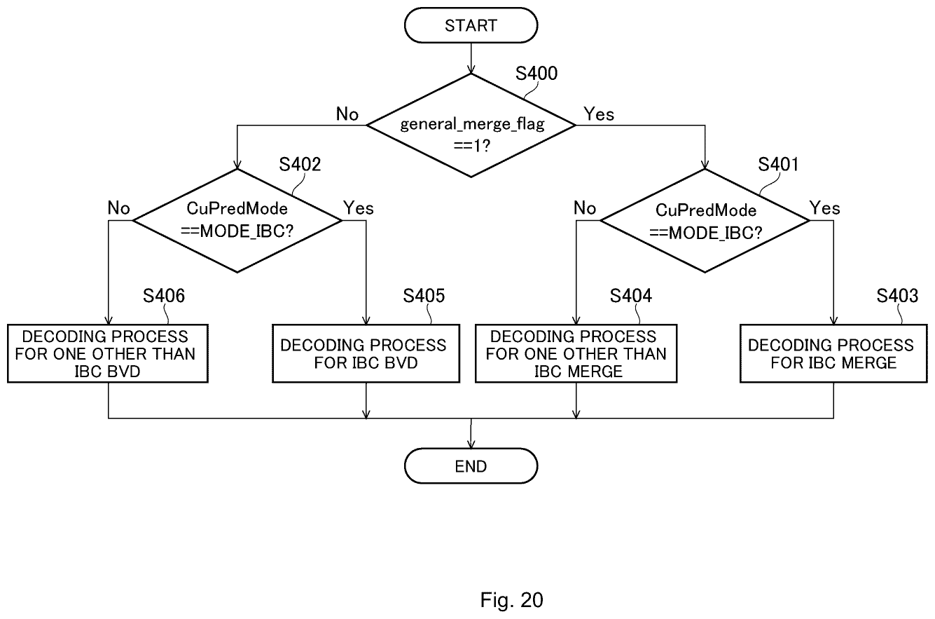

In the following, by using FIG. 20 to FIG. 23, a selection method of IBC mode selection (IBC BVP, IBC merge, or IBC BVP/merge described above) after the decoding processing in the decoding part 201 in FIG. 19 will be described.

FIG. 20 is a diagram illustrating an example of a method of selecting an IBC mode (IBC BVP, IBC merge, or IBC BVP/merge described above) in the decoding part 201.

As illustrated in FIG. 20, the decoding part 201 may select a unique mode from IBC modes (IBC BVP, IBC merge, and IBC BVP/merge described above). This is concretely as follows.

As illustrated in FIG. 20, in step S400, the decoding part 201 determines whether or not general_merge_flag is 1.

If Yes, this operation advances to step S401. If No, this operation advances to step S402.

Here, general_merge_flag is a flag for controlling (specifying) whether or not to apply inter-frame prediction or IBC merge in units of decoding target block.

When general_merge_flag is 1, this indicates that application of inter-frame prediction or IBC merge is valid. When general_merge_flag is 0, this indicates that application of inter-frame prediction or IBC merge is invalid.

In step S401, the decoding part 201 determines whether or not CuPredMode is MODE_IBC.

If Yes, this operation advances to step S403. If No, this operation advances to step S404.

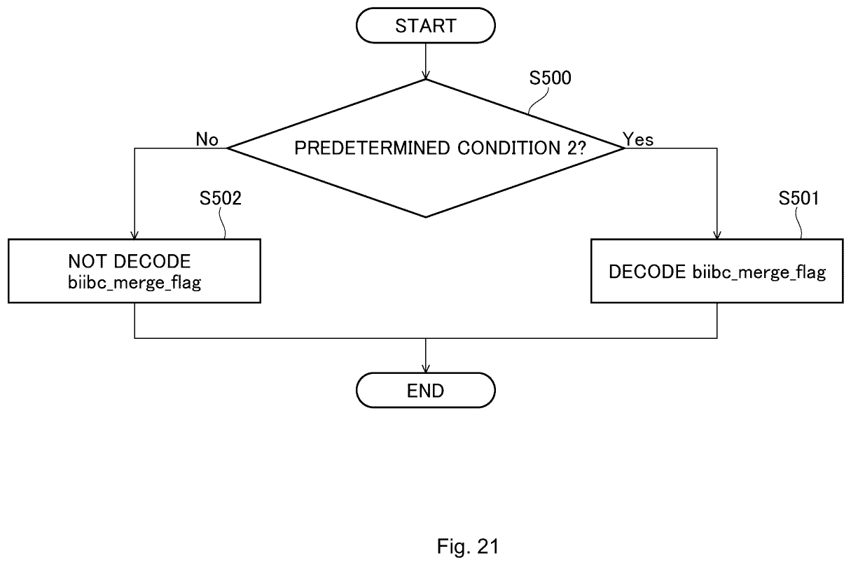

In step S403, the decoding part 201 changes to decoding processing related to IBC merge to be described below (described by using FIG. 21 to FIG. 23).

In step S404, the decoding part 201 changes to decoding processing related to other than IBC merge to be described below.

In step S402, the decoding part 201 determines whether or not CuPredMode is MODE_IBC.

If Yes, this operation advances to step S405. If No, this operation advances to step S406.

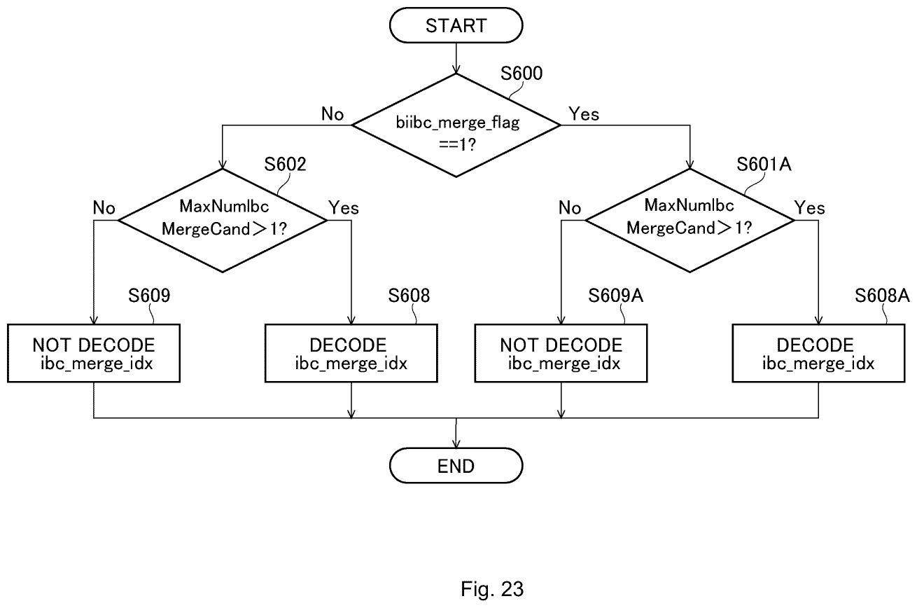

In step S405, the decoding part 201 changes to decoding processing related to IBC BVP to be described below (described by using FIG. 23).

In step S406, the decoding part 201 changes to decoding processing related to other than IBC BVP to be described below.

In the following, by using FIG. 21, a method of decoding a flag for controlling (specifying) whether or not bi-prediction IBC merge is valid in units of decoding target block (i.e., whether or not to apply bi-prediction IBC merge in units of decoding target block) in the decoding part 201 will be described.

FIG. 21 is a diagram illustrating an example of a method of decoding a flag for controlling (specifying) whether or not bi-prediction IBC merge is valid in units of decoding target block (i.e., whether or not to apply bi-prediction IBC merge in units of decoding target block) in the decoding part 201.

As illustrated in FIG. 21, the decoding part 201 may decode the flag for controlling (specifying) whether or not bi-prediction IBC merge is valid in units of decoding target block (whether to apply bi-prediction IBC merge in units of decoding target block). This is concretely as follows.

As illustrated in FIG. 21, in step S500, the decoding part 201 determines whether or not certain condition 2 is satisfied.

If Yes, this operation advances to step S501. If No, this operation advances to step S502.

In step S501, the decoding part 201 decodes biibc_merge_flag and terminates this processing.

In step S502, the decoding part 201 does not decode biibc_merge_flag and terminates this processing.

Here, biibc_merge_flag is a flag (fourth syntax) for controlling (specifying) whether or not to apply bi-prediction IBC merge in units of decoding target block.

The decoding part 201 identifies to apply bi-prediction IBC merge to the decoding target block when biibc_merge_flag is 1 while identifying not to apply bi-prediction IBC merge to the decoding target block when biibc_merge_flag is 0.

When biibc_merge_flag is not decoded, the decoding part 201 may infer that biibc_merge_flag is 0.

Certain condition 2 may include at least one condition of the following conditions.
1. sps_ibc_enabled_flag is 1.
2. sh_biibc_enabled_flag is 1 (and/or sps_biibc_enabled_flag is 1).
3. general_merge_flag is 1.
4. CuPredMode is IBC.
5. sh_slice_type is I or B.

As an alteration, a condition based on the block size (product of the numbers of pixels in the vertical direction and the horizontal direction) of the decoding target block may be added to certain condition 2.

For example, a condition that the block size of a decoding target block is 16 pixels or more or 32 pixels or more (or the horizontal width or the vertical width of the decoding target block is 8 pixels or more) may be added.

With this, application of bi-prediction IBC merge to a decoding target block being relatively small in size can be suppressed, and hence reduction of the amount of processing can be expected.

In contrast, a condition that the number of pixels is smaller than a threshold used for a determination condition for determining whether or not to apply unipredictional IBC merge, for example, the block size of the decoding target block is 32 pixel or less or 16 pixels or less may be added.

With this, application of bi-prediction IBC merge to a decoding target block being relatively large in size can be suppressed, and hence reduction of the amount of processing can be expected.

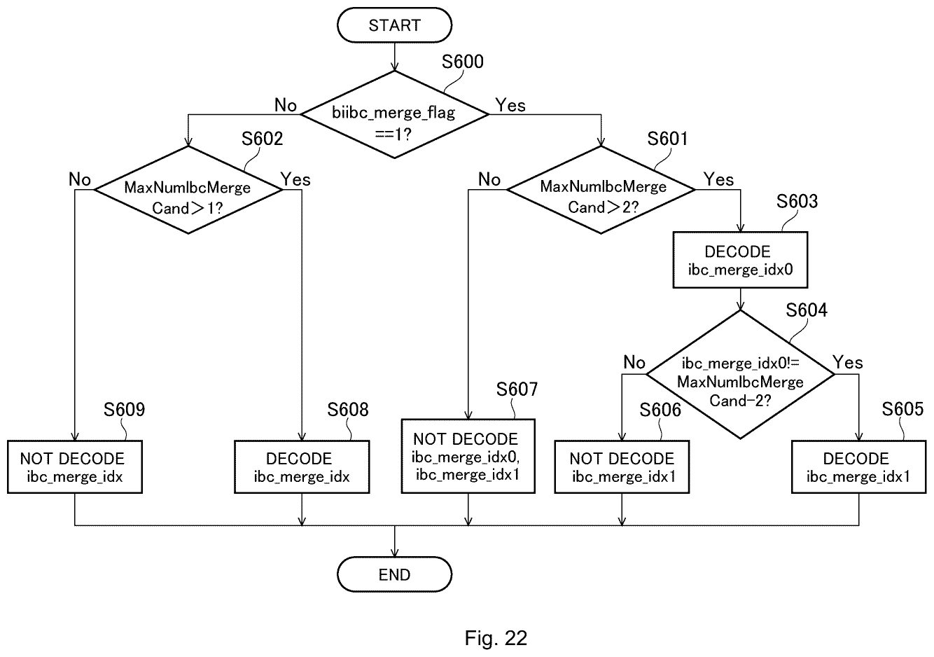

In the following, by using FIG. 22, a method of decoding control information related to IBC merge in the decoding part 201 will be described.

In IBC merge, to select one or more merge candidates from a merge candidate list described above, the decoding part 201 decodes an IBC merge index (fifth syntax) being control information for specifying a merge candidate in the merge candidate list.

FIG. 22 is a diagram illustrating an example of a method of decoding control information related to IBC merge in the decoding part 201.

As illustrated in FIG. 22, the decoding part 201 may control decoding of control information related to IBC merge. This is concretely as follows.

As illustrated in FIG. 22, in step S600, the decoding part 201 determines whether or not biibc_merge_flag is 1.

If Yes, this operation advances to step S601. If No, this operation advances to step S602.

In step S601, the decoding part 201 determines whether or not MaxNumIbcMergeCand is larger than 2.

If Yes (MaxNumIbcMergeCand is larger than 2), this operation advances to step S603. If No (MaxNumIbcMergeCand is 2 or smaller), this operation advances to step S607.

In step S603, the decoding part 201 decodes ibc_merge_idx0.

Here, ibc_merge_idx0 is the first IBC merge index (sixth syntax) in bi-prediction IBC merge.

In step S604, the decoding part 201 determines whether or not ibc_merge_idx0 is not MaxNumIbcMergeCand—2 (ibc_merge_idx0!=MaxNumIbcMergeCand—2).

If Yes, this operation advances to step S605. If No, this operation advances to step S606.

In step S605, the decoding part 201 decodes ibc_merge_idx1 and terminates this processing.

In step S606, the decoding part 201 does not decode ibc_merge_idx1 and terminates this processing.

Here, ibc_merge_idx1 is the second IBC merge index (seventh syntax) in bi-prediction IBC merge.

Here, in step S604, when the condition that ibc_merge_idx0 is not MaxNumIbcMergeCand—2 is not satisfied, in other words, ibc_merge_idx0 is MaxNumIbcMergeCand—2, ibc_merge_idx1 is obviously MaxNumIbcMergeCand—1 as will be described below.

Hence, by the decoding part 201 not decoding ibc_merge_idx1 in step S606, reduction of the code amount can be expected.

In step S607, the decoding part 201 does not decode ibc_merge_idx0 and ibc_merge_idx1 and terminates this processing.

Here, MaxNumIbcMergeCand is the maximum value of the number of merge candidates possible to be registered to a merge candidate list in IBC merge as described above. If MaxNumIbcMergeCand is 2 or smaller in step S601, an IBC merge candidate to be used is obvious without decoding two merge indices in bi-prediction IBC merge.

Hence, by the decoding part 201 not decoding ibc_merge_idx0 and ibc_merge_idx1 in step S607, reduction of the code amount can be expected.

In step S602, the decoding part 201 determines whether or not MaxNumIbcMergeCand is larger than 1.

If Yes, this operation advances to step S608. If No, this operation advances to step S609.

In step S608, the decoding part 201 decodes ibc_merge_idx and terminates this processing.

In step S609, the decoding part 201 does not decode ibc_merge_idx and terminates this processing.

Here, in step S602, if MaxNumIbcMergeCand is not larger than 1, in other words, MaxNumIbcMergeCand is 1, an IBC merge candidate to be used is obvious without decoding a merge index selected in unipredictional IBC merge.

Hence, by the decoding part 201 not decoding ibc_merge_idx in step S609, reduction of the code amount can be expected.

Note that, although merge indices of bi-prediction IBC merge (ibc_merge_idx0 and ibc_merge_idx1) and a merge index of unidirectional IBC merge (ibc_merge_idx) have been described separately above, ibc_merge_idx0 and ibc_merge_idx may be configured in common in the image decoding device 200.

Specifically, common design of a context value for decoding (coding) and a common method of decoding from a binary value to a value of a number system based on multiple numerals (coding from a value of a number system based on multiple numerals to a binary value) such as truncated binarization may be configured.

FIG. 23 is a diagram illustrating the alteration of a method of decoding control information related to IBC merge described by using FIG. 22 (constructing different lists as illustrated in FIG. 7 for the number of block vectors).

As illustrated in FIG. 23, the decoding part 201 may decode control information related to IBC merge. This is concretely as follows.

As illustrated in FIG. 23, in step S600, the decoding part 201 determines whether or not biibc_merge_flag is 1.

If Yes, this operation advances to step S601A. If No, this operation advances to step S602.

In step S601A, the decoding part 201 determines whether or not MaxNumIbcMergeCand is larger than 1.

If Yes, this operation advances to step S608A. If No (MaxNumIbcMergeCand is 1 or smaller), this operation advances to step S609A.

In step S608A, the decoding part 201 decodes ibc_merge_idx and terminates this processing.

In step S609A, the decoding part 201 does not decode ibc_merge_idx and terminates this processing.

Step S602, step S608, and step S609 are the same as those in FIG. 22.

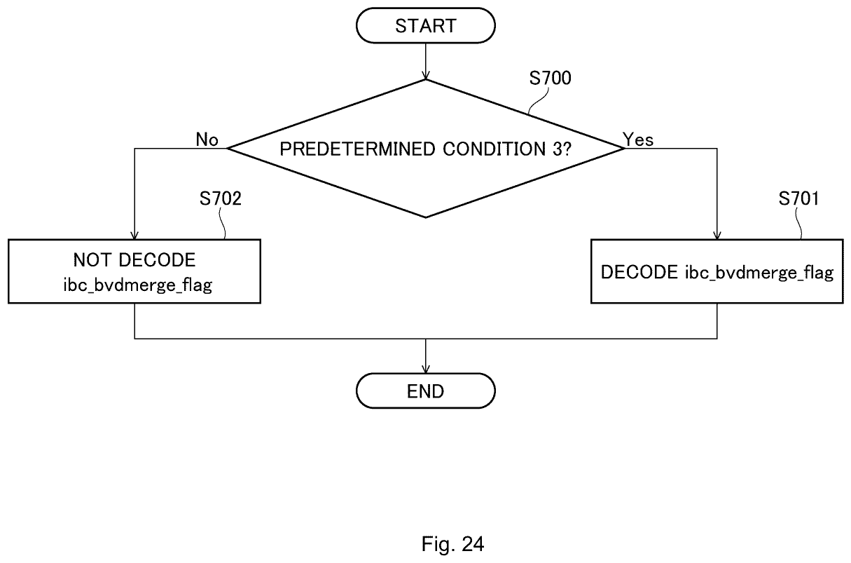

In the following, by using FIG. 24, a method of decoding a flag for controlling (specifying) whether or not IBC BVP/merge is valid in units of decoding target block (i.e., whether or not to apply IBC BVP/merge in units of decoding target block) in the decoding part 201 will be described.

FIG. 24 is a diagram illustrating an example of a method of decoding a flag for controlling (specifying) whether or not IBC BVP/merge is valid in units of decoding target block (i.e., whether or not to apply IBC BVP/merge in units of decoding target block) in the decoding part 201.

As illustrated in FIG. 24, the decoding part 201 may decode the flag for controlling (specifying) whether or not IBC BVP/merge is valid in units of decoding target block (whether to apply IBC BVP/merge in units of decoding target block). This is concretely as follows.

As illustrated in FIG. 24, in step S700, the decoding part 201 determines whether or not certain condition 3 is satisfied.

If Yes, this operation advances to step S701. If No, this operation advances to step S702.

In step S701, the decoding part 201 decodes ibc_bvpmerge_flag and terminates this processing.

In step S702, the decoding part 201 does not decode ibc_bvpmerge_flag and terminates this processing.

Here, ibc_bvpmerge_flag is a flag (eighth syntax) for controlling (specifying) whether or not IBC BVP/merge is valid in units of decoding target block (i.e., whether or not to apply IBC BVP/merge in units of decoding target block).

The decoding part 201 identifies to apply IBC BVP/merge to the decoding target block when ibc_bvpmerge_flag is 1 while identifying not to apply IBC BVP/merge to the decoding target block when ibc_bvpmerge_flag is 0.

When ibc_bvpmerge_flag is not decoded, the decoding part 201 may infer that ibc_bvpmerge_flag is 0.

Certain condition 3 may include at least one condition of the following conditions.
6. sps_ibc_enabled_flag is 1.
7. general_merge_flag is 1.
8. CuPredMode is IBC.
9. sh_slice_type is I or B.

As an alteration, a condition based on the block size (product of the numbers of pixels in the vertical direction and the horizontal direction) of the decoding target block may be added to certain condition 3.

For example, a condition that the block size of a decoding target block is 16 pixels or more or 32 pixels or more (or the horizontal width or the vertical width of the decoding target block is 8 pixels or more) may be added.

With this, application of IBC BVP/merge to a decoding target block being relatively small in size can be suppressed, and hence reduction of the amount of processing can be expected.

In contrast, a condition that the number of pixels is smaller than a threshold used for a determination condition for determining whether or not to apply unipredictional IBC merge, for example, the block size of the decoding target block is 32 pixel or less or 16 pixels or less may be added.

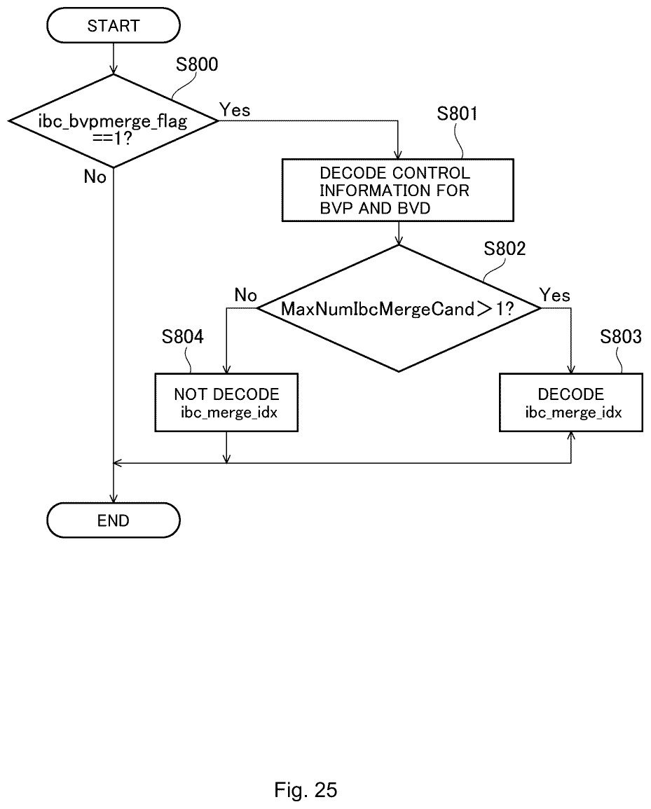

With this, application of IBC BVP/merge to a decoding target block being relatively large in size can be suppressed, and hence reduction of the amount of processing can be expected. In the following, by using FIG. 25, a method of decoding control information related to IBC BVP/merge in the decoding part 201 will be described.

FIG. 25 is a diagram illustrating an example of a method of decoding control information related to IBC BVP/merge in the decoding part 201.

As illustrated in FIG. 25, the decoding part 201 may decode control information related to IBC BVP/merge. This is concretely as follows.

As illustrated in FIG. 25, in step S800, the decoding part 201 determines whether or not ibc_bvpmerge_flag is 1.

If Yes, this operation advances to step S801. If No, this operation terminates this processing.

In step S801, the decoding part 201 decodes control information related to BVP and BVD and advances to step S802.

In step S802, the decoding part 201 determines whether or not MaxNumIbcMergeCand is larger than 1.

If Yes, this operation advances to step S803. If No (MaxNumIbcMergeCand is 1 or smaller), this operation advances to step S804.

In step S803, the decoding part 201 decodes ibc_merge_idx and terminates this processing.

In step S804, the decoding part 201 does not decode ibc_merge_idx and terminates this processing.

Here, MaxNumIbcMergeCand is the maximum value of the number of merge candidates possible to be registered to a merge candidate list in IBC merge as described above. If MaxNumIbcMergeCand is 1 or smaller in step S801, an IBC merge candidate to be used is obvious without decoding a merge index in IBC BVP/merge.

Hence, by the decoding part 201 not decoding ibc_merge_idx in step S804, reduction of the code amount can be expected.

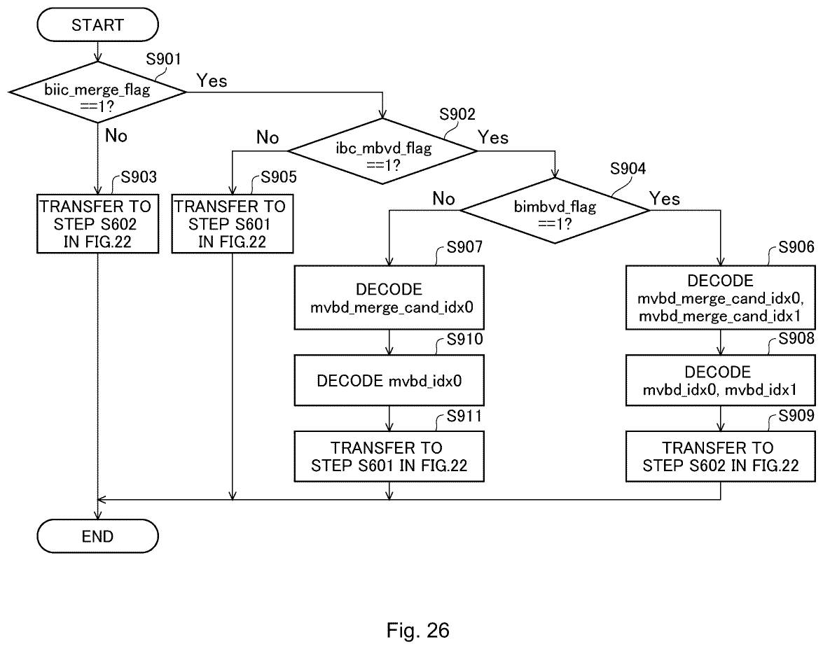

In the following, by using FIG. 26, a method of decoding control information related to MBVD described above for refining a BV of IBC in the decoding part 201 will be described.

FIG. 26 is a diagram illustrating an example of a method of decoding control information related to MBVD described above for refining a BV of IBC in the decoding part 201.

As illustrated in FIG. 26, the decoding part 201 may decode control information related to MBVD described above for refining a BV of IBC. This is concretely as follows.

As illustrated in FIG. 26, in step S901, the decoding part 201 determines whether or not biibc_merge_flag is 1.

If Yes, this operation advances to step S902. If No, this operation advances to step S903.

In step S902, the decoding part 201 determines whether or not ibc_mbvd_flag is 1.

If Yes, this operation advances to step S904. If No, this operation advances to step S905.

Here, ibc_mbvd_flag is a flag for controlling whether or not to apply MBVD in units of decoding target block.

The decoding part 201 identifies that MBVD is applied when ibc_mbvd_flag is 1 while identifying that MBVD is not applied when ibc_mbvd_flag is 0.

When ibc_mbvd_flag is not decoded, the decoding part 201 may infer that ibc_mbvd_flag is 0.

In step S904, the decoding part 201 determines whether or not bimbvd_flag is 1.

If Yes, this operation advances to step S906. If No, this operation advances to step S907.

Here, bimbvd_flag is a flag for controlling whether or not to apply MBVD to two pairs of merge candidates (BVs) in bi-prediction IBC merge in units of decoding target block.

The decoding part 201 identifies to apply MBVD to the two pairs of merge candidates (BVs) when bimbvd_flag is 1 while identifying not to apply MBVD to the two pairs of merge candidates (BVs) when bimbvd_flag is 0 (in other words, to apply MBVD only to one pair of merge candidates (BVs) in bi-prediction IBC merge).

When bimbvd_flag is not decoded, the decoding part 201 may infer that bimbvd_flag is 0.

In step S906, the decoding part 201 decodes mbvd_merge_cand_idx0 and mbvd_merge_cand_idx1.

Here, mbvd_merge_cand_idx0 is an index for selecting the first pair of merge candidates (BVs) to which MBVD is applied from the two pairs of merge candidates (BVs) in bi-prediction IBC merge in a merge candidate list in units of decoding target block.

When mbvd_merge_cand_idx0 is not decoded, the decoding part 201 may infer that mbvd_merge_cand_idx0 is 0.

mbvd_merge_cand_idx1 is an index for selecting the second pair of merge candidates (BVs) to which MBVD is applied from the two pairs of merge candidates (BVs) in bi-prediction IBC merge in the merge candidate list in units of decoding target block.

When mbvd_merge_cand_idx1 is not decoded, the decoding part 201 may infer that mbvd_merge_cand_idx1 is 0.

Note that, when mbvd_merge_cand_idx0 and mbvd_merge_cand_idx1 are decoded, the decoding part 201 may give no magnitude relationship to these, or may give the magnitude relationship mbvd_merge_cand_idx0<mbvd_merge_cand_idx1, in advance.

When no magnitude relationship is given, by decoding mbvd_merge_cand_idx0, then excluding the merge candidate corresponding to mbvd_merge_cand_idx0 from the merge candidate list, and then decoding mbvd_merge_cand_idx1, the decoding part 201 can derive different merge candidates even when mbvd_merge_cand_idx0 and mbvd_merge_cand_idx1 are the same, and hence improvement of coding efficiency can be expected.

It is an index for selecting the first pair of merge candidates (BVs) to which MBVD is applied from the two pairs of merge candidates (BVs) in bi-prediction IBC merge in the merge candidate list in units of decoding target block.

When mbvd_merge_cand_idx0 is not decoded, the decoding part 201 may infer that mbvd_merge_cand_idx0 is 0.

In step S908, the decoding part 201 decode mbvd_idx0 and mbvd_idx1 and terminates this processing.

Here, mbvd_idx0 and mbvd_idx1 are indices for deriving respective refined vectors for the first pair and the second pair of merge candidates of the two pairs of merge candidates (BVs) in bi-prediction IBC merge.

Concretely, the values of mbvd_idx0 and mbvd_idx1 correspond to possible discrete reference locations for the refined vectors as disclosed in NPL 2.

The discrete reference locations are defined by directions and distances of the refined vectors based on the BV of the merge candidate.

The directions may be constituted of above, bottom, left, and right (the total of four directions including vertical directions and horizontal directions) as in NPL 1 or may be constituted of eight directions obtained by adding four directions including 45 degrees, 135 degrees, 225 degrees, and 315 degrees to above, bottom, left, and right as in NPL 2.

When image precision of IBC is limited to integer precision (in other words, only integer precision pixels are selectable) in units of sequence, picture, slice, or decoding target block, the distances may each be constituted of 1 pixel, 4 pixels, 8 pixels, 12 pixels, 16 pixels, 24 pixels, 32 pixels, 40 pixels, 48 pixels, 56 pixels, 72 pixels, 80 pixels, 88 pixels, 96 pixels, 104 pixels, 112 pixels, 120 pixels, or 128 pixels, or the like as in NPL 2.

As another example, when pixel precision of IBC is not limited to integer precision (in other words, both decimal precision pixels and integer precision pixel are selectable) in units of sequence, picture, slice, or decoding target block, ¼ pixels, and ⅛ pixels may be added to options of integer pixels described above.

In step S909, the decoding part 201 advances to step S601 in FIG. 22, and, when this operation ends, terminates this processing.

In step S907, the decoding part 201 decodes mbvd_merge_cand_idx0.

In step S910, the decoding part 201 decodes mbvd_idx0.

In step S911, the decoding part 201 advances to step S601 in FIG. 22, and, when this operation ends, terminates this processing.

In step S905, the decoding part 201 advances to step S601 in FIG. 22, and, when this operation ends, terminates this processing.

In step S903, the decoding part 201 advances to step S602 in FIG. 22, and, when this operation ends, terminates this processing.

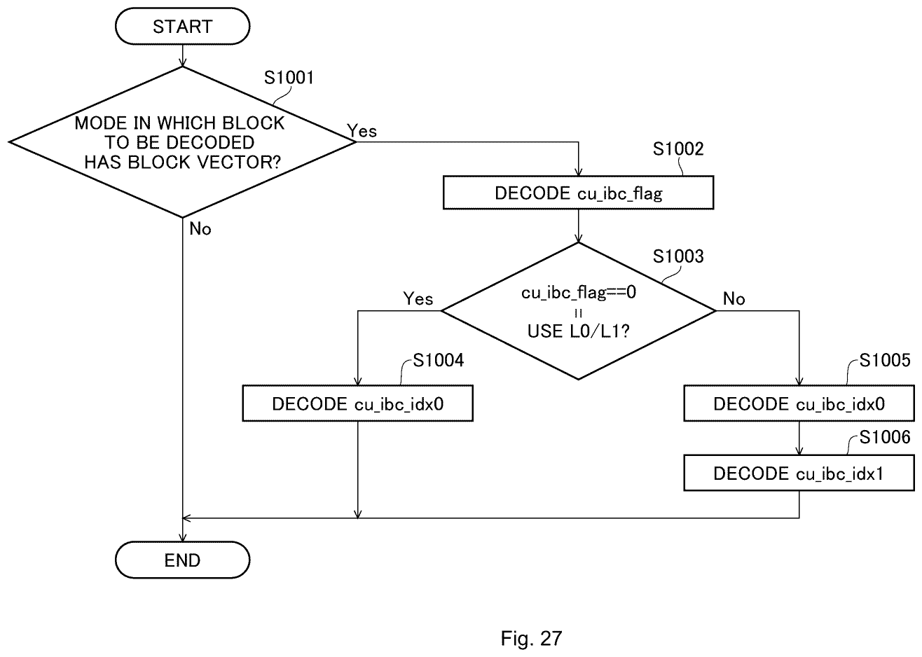

An alteration of the method of applying second intra-frame prediction in units of block will be described below with reference to FIG. 27.

As illustrated in FIG. 27, in step S1001, the decoding part 201 determines whether or not it is a mode that a decoding target block holds a BV.

If Yes, this operation advances to step S1002. If No, this operation is terminated.

In step S1002, the decoding part 201 decodes cu_ibc_flag, which is a control signal indicating the number of BVs to be used by second intra-frame prediction.

Here, by configuring the maximum number of BVs at two, the decoding part 201 performs decoding by assuming one BV when cu_ibc_flag is 0 while performing decoding by assuming two BVs when cu_ibc_flag is 1.

In step S1003, the decoding part 201 determines whether the number of BVs is one or two.

In other words, in step S1003, the decoding part 201 determines whether or not cu_ibc_flag is 0.

When the number of BVs is one (cu_ibc_flag==0) or a BVP candidate list uses L0 list and L1 list, the decoding part 201 decodes cu_ibc_idx0, which is a control signal for specifying a BV from the BVP candidate list, in step S1004.

When the number of BVs is not one (cu_ibc_flag!=0) and also the BVP candidate list is constituted of L0 list only, the decoding part 201 decodes cu_ibc_idx0 and cu_ibc_idx1, which are control signals for specifying BVs from the BVP candidate list, in step S1004 and step S1005.

When cu_ibc_idx1 is expressed by relative coordinates, the decoding part 201 decodes cu_ibc_idx0+cu_ibc_idx1 as cu_ibc_idx1 as absolute coordinates.

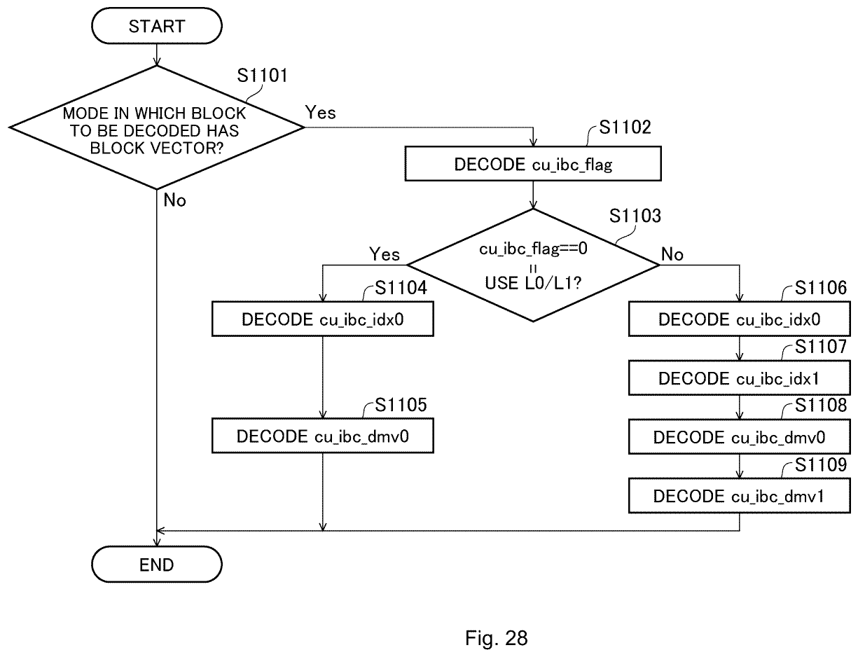

FIG. 28 is a flowchart of a case where a refinement BV is applied to BV.

As illustrated in FIG. 28, in step S1101, the decoding part 201 determines whether or not it is a mode that a decoding target block holds a BV.

If Yes, this operation advances to step S1102. If No, this operation is terminated.

In step S1102, the decoding part 201 decodes cu_ibc_flag, which is a control signal indicating the number of BVs to be used by second intra-frame prediction.

Here, by configuring the maximum number of BVs at two, the decoding part 201 performs decoding by assuming one BV when cu_ibc_flag is 0 while performing decoding by assuming two BVs when cu_ibc_flag is 1.

In step S1103, the decoding part 201 determines whether the number of BVs is one or two.

In other words, in step S1103, the decoding part 201 determines whether or not cu_ibc_flag is 0.

When the number of BVs is one (cu_ibc_flag==0) or a BVP candidate list uses L0 list and L1 list, the decoding part 201 decodes cu_ibc_idx0, which is a control signal for specifying a BV from the BVP candidate list, in step S1104.

In step S1105, the decoding part 201 decodes cu_ibc_dmv0, which is control information indicating a refinement BV, and adds cu_ibc_dmv0 to the BV.

When the number of BVs is not one (cu_ibc_flag!=0) and also the BVP candidate list is constituted of L0 list only, the decoding part 201 decodes cu_ibc_idx0 and cu_ibc_idx1, which are control signals for specifying BVs from the BVP candidate list, in step S1106 and step S1107.

When cu_ibc_idx1 is expressed by relative coordinates, the decoding part 201 decodes cu_ibc_idx0+cu_ibc_idx1 as cu_ibc_idx1 as absolute coordinates.

In step S1108 and step S1109, the decoding part 201 decodes cu_ibc_dmv0 and cu_ibc_dmv1, which are each control information indicating a refinement BV, and adds cu_ibc_dmv0 and cu_ibc_dmv1 to the respective BVs.

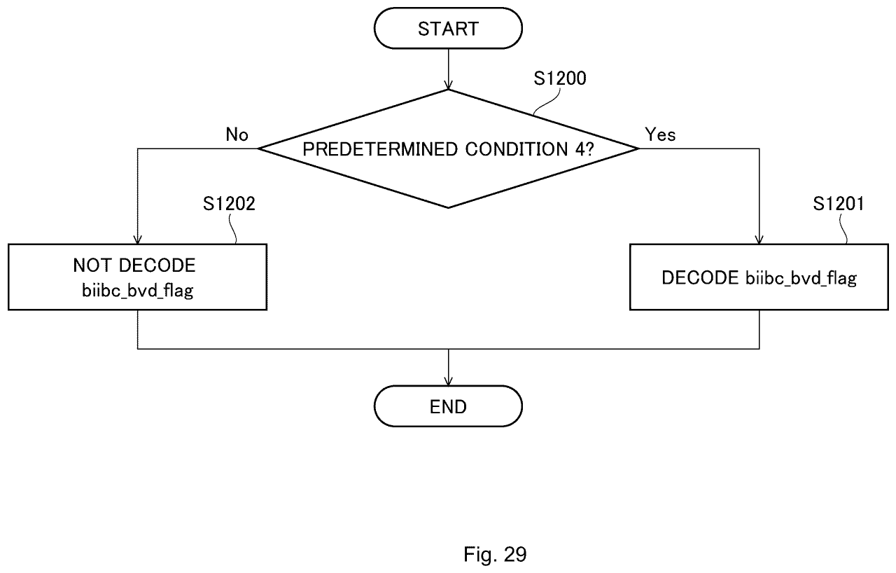

In the following, by using FIG. 29, a method of decoding a flag for controlling (specifying) whether or not bi-prediction IBC BVP is valid in units of decoding target block (i.e., whether or not to apply bi-prediction IBC BVP in units of decoding target block) in the decoding part 201 will be described.

FIG. 29 is a flowchart illustrating an example of a method of decoding a flag for controlling (specifying) whether or not bi-prediction IBC BVP is valid in units of decoding target block (i.e., whether or not to apply bi-prediction IBC BVP in units of decoding target block) in the decoding part 201.

As illustrated in FIG. 29, the decoding part 201 may decode the flag for controlling (specifying) whether or not bi-prediction IBC BVP is valid in units of decoding target block (whether to apply bi-prediction IBC BVP in units of decoding target block). This is concretely as follows.

As illustrated in FIG. 29, in step S1200, the decoding part 201 determines whether or not certain condition 4 is satisfied.

If Yes, this operation advances to step S1201. If No, this operation advances to step S1202.

In step S1201, the decoding part 201 decodes biibc_bvp_flag and terminates this processing.

In step S1202, the decoding part 201 does not decode biibc_bvp_flag and terminates this processing.

Here, biibc_bvp_flag is a flag (ninth syntax) for controlling (specifying) whether or not to apply bi-prediction IBC BVP in units of decoding target block.

The decoding part 201 identifies to apply bi-prediction IBC BVP to the decoding target block when biibc_bvp_flag is 1 while identifying not to apply bi-prediction IBC BVP to the decoding target block when biibc_bvp_flag is 0.

When biibc_bvp_flag is not decoded, the decoding part 201 may infer that biibc_bvp_flag is 0.

Certain condition 4 may include at least one condition of the following conditions.
1. sps_ibc_enabled_flag is 1.
2. sh_biibc_enabled_flag is 1 (and/or sps_biibc_enabled_flag is 1).
3. general_merge_flag is 0.
4. CuPredMode is IBC.
5. sh_slice_type is I or B.

As an alteration, a condition based on the block size (product of the numbers of pixels in the vertical direction and the horizontal direction) of the decoding target block may be added to certain condition 4.

For example, a condition that the block size of a decoding target block is 16 pixels or more or 32 pixels or more (or the horizontal width or the vertical width of the decoding target block is 8 pixels or more) may be added.

With this, application of bi-prediction IBC merge to a decoding target block being relatively small in size can be suppressed, and hence reduction of the amount of processing can be expected.

In contrast, a condition that the number of pixels is smaller than a threshold used for a determination condition for determining whether or not to apply unipredictional IBC BVP, for example, the block size of the decoding target block is 32 pixel or less or 16 pixels or less may be added.

With this, application of bi-prediction IBC BVP to a decoding target block being relatively large in size can be suppressed, and hence reduction of the amount of processing can be expected.

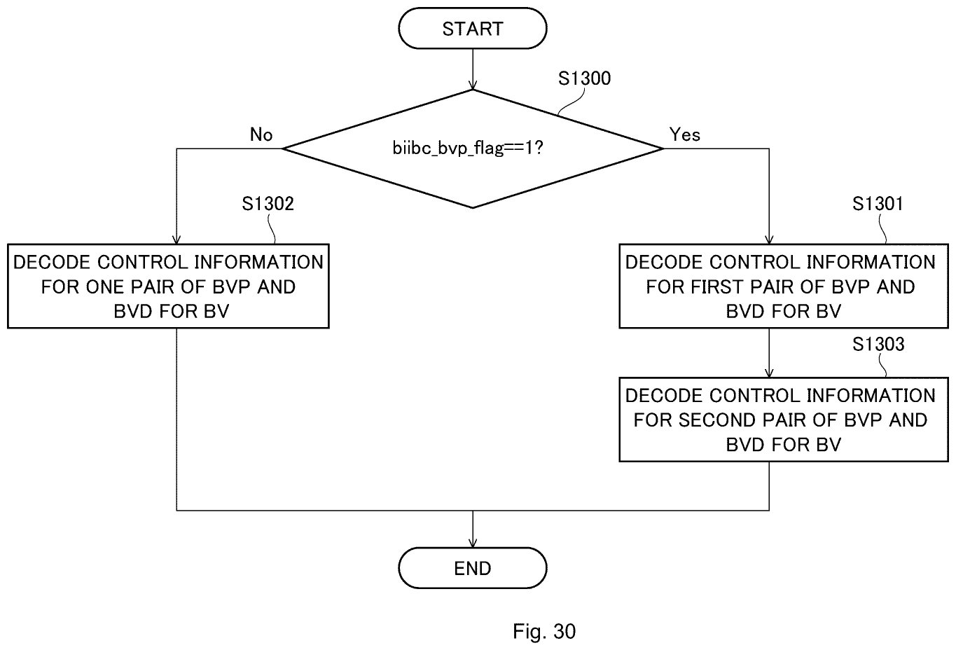

In the following, by using FIG. 30, a method of decoding control information related to BBC BVP in the decoding part 201 will be described.

FIG. 30 is a flowchart illustrating an example of a method of decoding control information related to IBC BVP in the decoding part 201.

As illustrated in FIG. 30, the decoding part 201 may control decoding of control information related to IBC BVP. This is concretely as follows.

As illustrated in FIG. 30, in step S1300, the decoding part 201 determines whether or not biibc_bvp_flag is 1.

If Yes, this operation advances to step S1301. If No, this operation advances to step S1302.

In step S1301, the decoding part 201 decodes control information related to the first pair of BVP and BVD of two pairs of BVP and BVD in bi-prediction IBC BVP.

In step S1303, the decoding part 201 decodes control information related to the second pair of BVP and BVD of the two pairs of BVP and BVD in bi-prediction IBC BVP and terminates this processing.

In step S1302, the decoding part 201 decodes control information related to one pair of BVP and BVD in bi-prediction IBC BVP and terminates this processing.

### (Binarization in Bi-Prediction IBC)

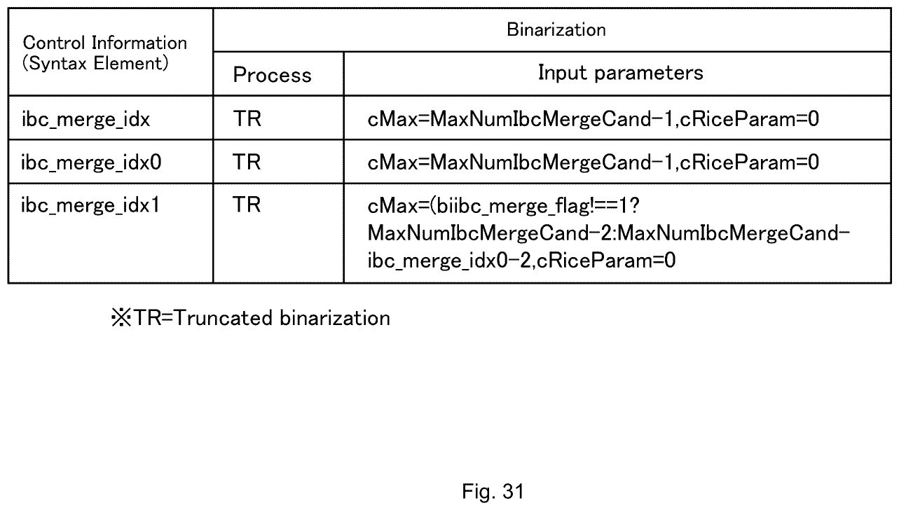

By using FIG. 31, a method of binarization of an IBC merge index described above in the decoding part 201 will be described.

FIG. 31 is a diagram illustrating an example of a method of binarization of an IBC merge index described above in the decoding part 201.

As illustrated in FIG. 31, the decoding part 201 may subject an IBC merge index to binarization. This is concretely as follows.

First, the decoding part 201 may use MaxNumIbcMerge—1 as the value of cMax for ibc_merge_idx.

Here, cMax denotes the possible maximum value using a number system based on multiple numerals before binarization for target control information.

Second, the decoding part 201 may use MaxNumIbcMerge—1 as the value of cMax for ibc_merge_idx0.

Third, the decoding part 201 may change the value of cMax depending on whether or not biibc_merge_flag is 1 for ibc_merge_idx1.

Concretely, when biibc_merge_flag is not 1, the decoding part 201 may use MaxNumIbcMerge—2 as the value of cMax.

In contrast, when biibc_merge_flag is 1, the decoding part 201 may use MaxNumIbcMerge—ibc_merge_idx0—2 as the value of cMax.

In other words, when two different indices (ibc_merge_idx0 and ibc_merge_idx1) are used to derive two BVs, the range of possible values for ibc_merge_idx1 is from 0 (minimum value) to a value obtained by subtracting the value of idx0 from the maximum value in the BVP candidate list (MaxNumIbcMerge—2 in the above-described example).

As above, by designing such a binarization method, the decoding part 201 can decode each of the second and subsequent indices described above, as a relative index based on an immediately previous index.

The image decoding device 200 described above may be implemented as a program for causing a computer to execute each function (each step).

### INDUSTRIAL APPLICABILITY

Note that, according to the present embodiment, for example, it is possible to achieve improvement of the total service quality in video communication. Hence, it is possible to contribute to Goal 9 “build resilient infrastructure, promote sustainable industrialization and foster innovation” of the Sustainable Development Goals (SDGs) initiated by the United Nations.

### REFERENCE SIGNS LIST

200 Image Decoding Device
201 Decoding Part
202 Dequantizing Part
203 Inverse Transforming Part
204 First Intra-frame Predicting Part
205 Second Intra-frame Predicting Part
205A Block Vector Deriving Part (BV Deriving Part)
205B Second Intra-frame Predicted Pixel Generating Part
206 Inter-frame Predicting Part
207 Adder
208 Storing Part
210 Code Inputting Part
220 Image Outputting Part

1. An image decoding device comprising:
a memory storing instructions; and
one or more processors configured to execute the instructions to:
decode control information and quantization values;
dequantize the quantization values to derive transform coefficients;
inverse-transform the transform coefficients to derive a prediction residual;
generate first predicted pixels based on decoded pixels and the control information;
construct a block vector candidate list, derive one or more block vectors for a block to be decoded from the block vector candidate list and generate second predicted pixels from the block vectors, based on the decoded pixels and the control information;
generate, from two or more block vectors with integer pixel precision or fractional pixel precision for a block to be decoded, the second predicted pixels based on the decoded pixels and the control information;
store the decoded pixels;
generate third predicted pixels based on the stored decoded pixels and the control information; and
add the prediction residual and the first predicted pixels to the third predicted pixels to derive the decoded pixels.

2. The image decoding device according to claim 1, wherein
the one or more processors are further configured to execute the instructions to register, if one or more decoded adjacent blocks adjacent to the block to be decoded have block vectors, the block vectors with the block vector candidate list.

3. The image decoding device according to claim 1, wherein
the one or more processors are further configured to execute the instructions to register, if one or more decoded neighboring blocks neighboring the block to be decoded have block vectors, the block vectors with the block vector candidate list.

4. The image decoding device according to claim 3, wherein
the one or more processors are further configured to execute the instructions to store, if one or more decoded neighboring blocks neighboring the block to be decoded have block vectors, the block vectors in history.

5. The image decoding device according to claim 1, wherein
the one or more processors are further configured to execute the instructions to weighted average two registered different block vectors to register block vectors different from registered block vectors with the block vector candidate list.

6. The image decoding device according to claim 1, wherein
the one or more processors are further configured to execute the instructions to determine, if block vectors that are checked to be available for the block vector candidate list match exactly registered block vectors, that block vectors for candidates to be newly registered are not available for the block vector candidate list.

7. The image decoding device according to claim 1, wherein
the one or more processors are further configured to execute the instructions to determine, if difference between block vectors for candidates to be newly registered for the block vector candidate list and block vectors that are checked to be available for the block vector candidate list is smaller than a preset threshold, that the block vectors for candidates to be newly registered are not available for the block vector candidate list.

8. The image decoding device according to claim 1, wherein
the one or more processors are further configured to execute the instructions to reorder a registering order for block vector candidates that can be registered with the block vector candidate list, depending on similarity of the block vectors.

9. The image decoding device according to claim 1, wherein
the one or more processors are further configured to execute the instructions to limit to the block vector candidate list, a range for a registering order for block vector candidates.

10. The image decoding device according to claim 7, wherein
the one or more processors are further configured to execute the instructions to evaluate, using neighboring pixels of the block to be decoded as a template, similarity with the neighboring pixels of reference for each block vector candidate in the block vector candidate list and reorder the block vector candidates in the block vector candidate list in an order of similarity.

11. The image decoding device according to claim 7, wherein
the one or more processors are further configured to execute the instructions to evaluate, using neighboring pixels of reference blocks for derived first block vector, similarity with the neighboring pixels of the reference blocks for each block vector candidate in the block vector candidate list and reorder the block vector candidates in the block vector candidate list in an order of similarity.

12. The image decoding device according to claim 1, wherein
the one or more processors are further configured to execute the instructions to use similarity between reference blocks for derived first block vector and reference blocks for each block vector candidate in the block vector candidate list for reordering each block vector candidate in the block vector candidate list.

13. The image decoding device according to claim 4, wherein
the one or more processors are further configured to execute the instructions not to store, if block vectors for candidates to be newly registered in history match exactly stored block vectors, the block vectors for the candidates to be newly registered in history.

14. The image decoding device according to claim 4, wherein
the one or more processors are further configured to execute the instructions not to store, if difference between block vectors for candidates to be newly registered in history and stored block vectors is smaller than a preset threshold, the block vectors for the candidates to be newly registered in history.

15. The image decoding device according to claim 1, wherein
the one or more processors are further configured to execute the instructions to determine, if pixel precision for block vectors derived finally by applying to the block to be decoded technique for changing the pixel precision for the block vectors is larger than relative to a case of not applying the technique, whether or not to use the pixel precision for the block vector candidates extracted from neighboring blocks of the block to be decoded with rounding to the pixel precision for the finally derived block vectors in order to determine whether or not to be available for the block vector candidate list.

16. The image decoding device according to claim 15, wherein
the one or more processors are further configured to execute the instructions to construct, if two or more block vector candidate lists are used and the pixel precision for the block vector candidates in at least one block vector candidate list is rounded with the technique in deriving the block vectors, the block vector candidate list with rounding the pixel precision for the block vector candidates in other block vector candidate list with same pixel precision.

17. The image decoding device according to claim 15, wherein
the one or more processors are further configured to execute the instructions to construct, if two or more block vector candidate lists are used and the pixel precision for the block vector candidates in at least one block vector candidate list is rounded with the technique in deriving the block vectors, the block vector candidate list without rounding the pixel precision for the block vector candidates in other block vector candidate list.

18. A decoding method comprising:
decoding control information and quantization values;
dequantizing the quantization values to derive transform coefficients;
inverse-transforming the transform coefficients to derive a prediction residual;
generating first predicted pixels based on decoded pixels and the control information;
constructing a block vector candidate list, derive one or more block vectors for a block to be decoded from the block vector candidate list and generate second predicted pixels from the block vectors, based on the decoded pixels and the control information;
generating, from two or more block vectors with integer pixel precision or fractional pixel precision for a block to be decoded, the second predicted pixels based on the decoded pixels and the control information;
storing the decoded pixels;
generating third predicted pixels based on the stored decoded pixels and the control information; and
adding the prediction residual and the first predicted pixels to the third predicted pixels to derive the decoded pixels.

19. A computer-readable non-transitory tangible storage medium storing thereon a program causing, when executed, one or more processors in a first wireless communication apparatus to execute:
decode control information and quantization values;
dequantize the quantization values to derive transform coefficients;
inverse-transform the transform coefficients to derive a prediction residual;
generate first predicted pixels based on decoded pixels and the control information;
construct a block vector candidate list, derive one or more block vectors for a block to be decoded from the block vector candidate list and generate second predicted pixels from the block vectors, based on the decoded pixels and the control information;
generate, from two or more block vectors with integer pixel precision or fractional pixel precision for a block to be decoded, the second predicted pixels based on the decoded pixels and the control information;
store the decoded pixels;
generate third predicted pixels based on the stored decoded pixels and the control information; and
add the prediction residual and the first predicted pixels to the third predicted pixels to derive the decoded pixels.
